(19) United States
(12) Patent Application Publication
(10) Pub. No.: US 2016/0231936 A1
(43) Pub. Date: Aug. 11, 2016

(54) IN-MEMORY VARIABLE META DATA SYSTEM AND METHOD

(71) Applicant: Eugene Edwin Nelson, Maple Grove, MN (US)

(72) Inventor: Eugene Edwin Nelson, Maple Grove, MN (US)

(21) Appl. No.: 14/619,798

(22) Filed: Feb. 11, 2015

(51) Int. Cl. G06F 3/06

(52) U.S. Cl. CPC G06F 3/0604; G06F 3/0661; G06F 3/0673

(57) ABSTRACT

A system and method are presented that improve transformation processing of program data stored in RAM. For all data structures (objects) with real data stored in RAM, metadata defining the schema (including all data types) for those data structures are also stored in RAM. The metadata provides the information necessary to transform the data in RAM between formats. In one embodiment, data and metadata are held within a recursive and hierarchical set of convenience classes. These convenience classes define the schema, and provide links to appropriate transform algorithms to be used during data transformation.

### FIELD OF THE INVENTION

The present application relates to the field of variable memory management in the field of computer programming for the purpose of inter-computer communications. More particularly, the described embodiments relate to a system and method for continually storing in random access memory metadata relating to variable classes whenever live data for those variable classes are also stored in memory. The metadata is used for the transmission and reception of variable data, especially in serial and human readable text formats.

### SUMMARY

Computer makers have created a wide variety of computers with different machine instruction sets. The most efficient data representation of in-memory and stored information is that supported by the local computer. A fundamental problem created by computers with different data representations is what to do when data is exchanged between computers. The earliest exchange of data between computers placed the burden of dealing with this problem on an application programmer. Either the sender or receiver translates data format while keeping the data content the same. Various organizations have attempted to ease the fundamental problem of data conversion by creating standards for how data is represented and converted. One approach is to define a universal serial binary format that is computer independent. A sender converts data from the local computer format into the universal serial format. A receiver converts data from this format into the local computer format. Another approach is to define a human readable text format that is computer independent, such as XML. A sender computer converts data from the local computer format into text. A receiver computer converts, or parses, the text into the local computer format. The problem with each approach is that a programmer must specifically program translation routines to and from these defined formats.

A compiler is a software tool that enables a programmer to simply and accurately implement an algorithm. A compiler language is an abstract specification of essential algorithm details that hide machine instruction details. A compiler processes a user program written in the compiler language, detects any errors and generates run time machine instructions. A compiler is able to hide differences in computer data representation most of the time. Unfortunately, the exchange of data between computers has proven to be a most difficult problem to hide. Class oriented compilers such as Java, C# and C++ support a user written class that encompasses data attributes and instruction sequences behind an interface contract of callable methods with passed parameters. Class based compilers have a feature called RPC (remote procedure call) that combines the ability to pass data between computers and cause class algorithm execution on a remote computer. The advantage is that computer differences are hidden by the compiler. The disadvantages include: 1) failure of a remote computer cannot be hidden; automatic transfer of referenced class instances frequently transfers unintended data; 2) ease of compromising security of a client or server computer; and 3) minimal support for class changes which affect data content.

One embodiment of the present invention addresses this situation by representing data within local RAM along with a schema of metadata. The metadata provides the information necessary to transform the data in RAM between formats. Data and metadata are held within a recursive and hierarchical set of convenience classes. A program defines and accesses data via a class based on these convenience classes. A human user accesses data via a text format similar to XML. A serial format is used for computer-to-computer transmission and persistent storage of data. This embodiment uses the metadata to identify appropriate transform algorithms to transform the data content between convenience class format and serial format as well as between convenience class format and a human-readable text format.

### BRIEF DESCRIPTION OF THE DRAWINGS

FIG. 1 is a schematic view of a system utilizing the present invention.

FIG. 2 is a schematic diagram of the class structure used by the system of FIG. 1.

FIG. 3 is a flow chart showing a method of transmitting in-memory variable data via a serial transmission.

FIG. 4 is a schematic view of a serial data stream.

FIG. 5 is a schematic view of a header format used in the serial data stream of FIG. 4.

FIG. 6 is a schematic view of a serial data stream for a gcData class which itself contains other gcData classes.

FIG. 7 is a flow chart showing a method of using received serial data.

FIG. 8 is a flow chart showing a method of using serial data as a data file.

FIG. 9 is a flow chart showing a method of creating human-readable data from in-memory variable data.

FIG. 10 is a schematic view illustrating an alternative embodiment of a portion of the system shown in FIG. 1.

FIG. 11 is a schematic view illustrating another alternative embodiment of a portion of the system shown in FIG. 1.

### DETAILED DESCRIPTION

### System 100

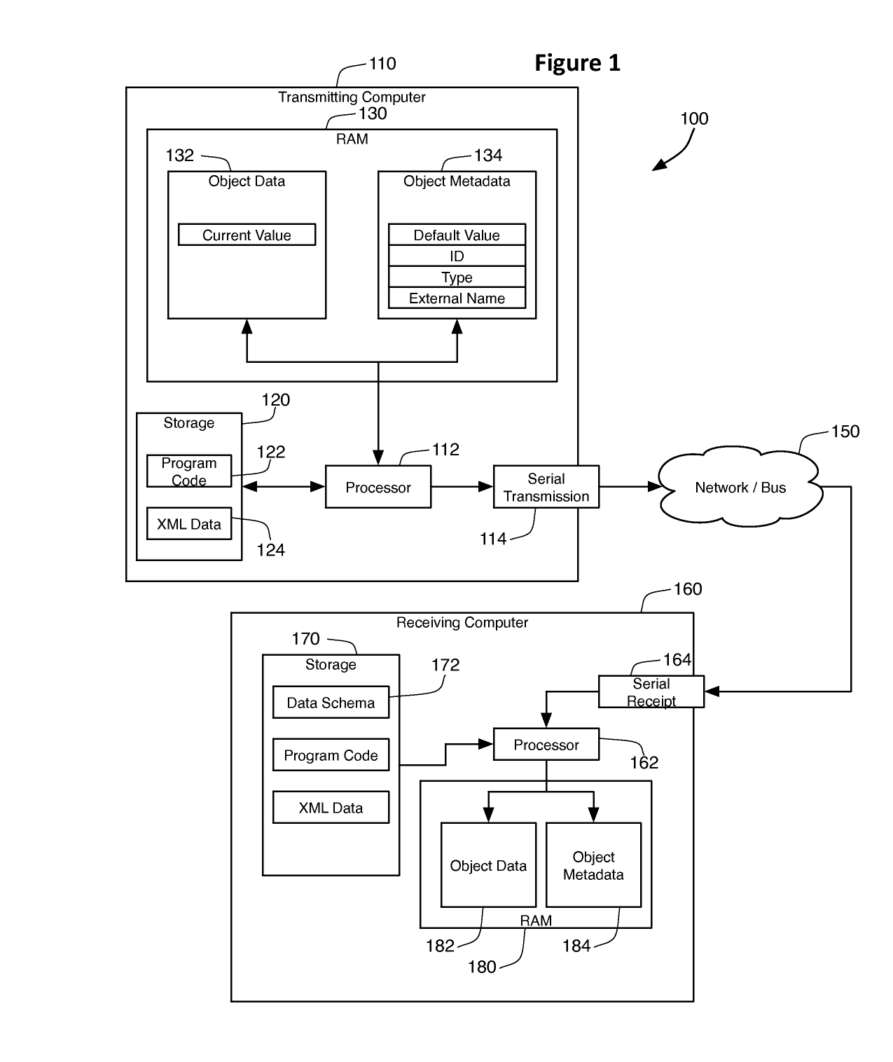

FIG. 1 shows a system 100 that utilizes the disclosed embodiments to simplify the serial transfer of data from one computer 110 to another 160. The transfer of data typically takes place over a network 150 such as the Internet or a TCP/IP local area network (or any other type of inter-computer network using serial based networking protocols). Alternatively, the transfer of data can take place over a serial bus 150. For the purposes of this disclosure, it will be assumed that the communication between the transmitting computer 110 and the receiving computer 160 takes place over a serial-based network 150.

The transmitting computer 110 is a typical computing system known in the prior art. As such, the computer 110 utilizes a processor 112 that operates according to computer programming instructions. These instructions may be stored in a non-transitory data store 120, such as flash memory or a hard disk drive. In FIG. 1, this data storage 120 is shown located within the physical structure of computer 110. In alternative embodiments, this storage 120 may be locally attached external storage, or even remote storage that is received over a computer network such as network 150. Programming instructions for the processor 112 can be stored in the storage 120 as compiled object code 122. When the computer 110 wishes to perform the instructions contained in the compiled programming code 122, such code is typically loaded into and executed in random access memory or RAM 130. Transitory RAM typically operates much faster than non-transitory storage, and so moving the compiled programming code 122 to RAM 130 for operation frequently speeds up the operation of the computer. In some embodiments, the programming code executed by the processor 112 is not compiled into object code but is implemented using some other method (such as through the use of an interpreter). In this context, the code 122 is still transferred to the computer's RAM 130 for faster execution by the interpreter.

When performing the instructions specified in code 122, the processor 112 will store and maintain variables 132 that are created and used by the code 122. When the code 122 is developed in an object-oriented programming language, such as Java, C++, Perl, and C#, the variables 132 will generally take the form of objects that are instances of classes defined by the programming code 122. An object is an abstract data type designed based on the concept of class inheritance and hierarchies. An individual object may incorporate both data and programming code in the form of methods. The data in an object may be highly structured, built on one or more simpler, primitive data types. For instance, an “address” object may incorporate text based primitives for the street name, city, and state, and integer primitives for the numeric house number or postal code. The described embodiment relates to the handling, translation, and transmission of this type of object data. In FIG. 1, this object data 132 is stored in RAM and is created, manipulated, and otherwise updated by the processor 112 according to the instructions of the code 122.

In FIG. 1, the processor 112 keeps not only the actual object data 132 in memory, but also keeps in memory the variable metadata (or “schema”) 134 that defines the structure of each object 132 that is kept in memory. By keeping the scheme 134 for each data object 132 in RAM 130, the processor 112 is able to easily perform the various methods described below for transmitting the data 132 to the remote computer 160. In these methods, the processor 112 may receive a request to transmit this data 132 to the receiving computer 160 via a serial based communication path 150. The processor will prepare the data in a serial format using the schema 134 that it keeps in RAM 130 to properly format each object 132. The formatted serial stream is then transmitted over the network 150 using some type of serial transmission hardware 114, such as a TCP/IP network interface. While the serial stream is formatted according to the object's schema, the actual schema is not transmitted in this serial data. Instead, only a scheme name is transmitted.

Traditionally, computer implementations of programmed code will maintain only the current value 132 of a variable in the computer's RAM 130. By maintaining metadata 134 in the RAM 130, the present embodiment greatly simplifies the task of translating these current values into serial data streams and human readable text files. In the embodiment shown in FIG. 1, the RAM 130 contains i) the default value, ii) a unique identifier, iii) a data type, and iv) an external name metadata 134 for each current value 132 that it maintains in memory. This is true for each instance of a class that is being managed by the described embodiment. The result of this is that up to ten times as much RAM 130 must be used because of this metadata 134 as compared to traditional systems that maintain only the current value 132 for each class instantiation. Thus, the present embodiment is inefficient in terms of memory utilization, but makes up for this in the simplification of data transformation.

The default value and unique identifier metadata 134 are used so that the disclosed embodiment can identify situations where the current value 132 for a variable is the same as the default value. In these circumstance, the serial transmission of the data can skip this value. The skipping of default values can greatly decrease the size of the serial transmission. However, in order for the receiving computer 160 to properly identify transmitted values (and therefore identify skipped, default values), each value transmitted must be associated with a unique identifier. The data type metadata 134 is used so that the serial transmission will identify the data type as well as the identifier for each element of transmitted data. The data type metadata 134 is used to identify the appropriate transfer methods that convert this data to a serial data stream or to human-readable data. While the receiving computer 160 should already known the data type for each data element (as it has knowledge of the entire data schema of the transmitted data), the redundant transmission of the data type across the serial data connection allows for an additional level of error checking. If the receiving computer 160 believes that a particular data element should be of one data type, but the receiving data stream identifies it as another data type, then the error can be immediately detected. The external name metadata 134 is useful when creating human readable text (such as XML formatted text), as is described in more detail below.

This metadata can be maintained in RAM 130 without altering the compiler used to compile the program code 122. This is accomplished by having the programmer define their classes using “convenience classes” as described in more detail below. Convenience classes are defined for all possible primitives as well as for more complex data structures. The convenience classes are designed to store the current value 132 for a variable as well as the default value, ID, data type, and external name for the variable. The programmer need only be concerned with the current value 132, while the convenience class used by the programmer maintains the related metadata 134 in memory. These convenience classes also are able to extract the data and metadata necessary from each class as is required to complete the serial and human readable data conversions described below.

The receiving computer 160 receives this serial stream over similar interface hardware 164. A processor 162 operating on the receiving computer 160 interprets the serial stream and then reconstructs the object data 182 in its RAM 180. The received serial data will identify the structure of the incoming object data through the schema name. The receiving computer 160 is responsible for identifying the schema name and retrieving the full schema (the object metadata) 172, which may be stored in its non-transitory storage 170. By accessing its own copy of the object metadata 172, the receiving computer 160 can reconstruct the object data 182 as appropriate for its own operation. Of course, this embodiment requires that the receiving computer 160 be pre-informed of the structure of the incoming data by having this data scheme 172 stored in an accessible manner. It is also expected that the receiving computer will contain all the business logic necessary to take full advantage of the incoming data that it receives, although it would be possible for the receiving computer 160 to simply save the incoming data stream as a data file in storage 170. It will frequently be the case that the actual implementation of the object data 182 in the receiving computer's RAM 180 will be different than the implementation of the same object data 132 in the transmitting computer's RAM 110. This would be the case, for instance, if the receiving computer 160 used a different processor, or a different operating system, or even a different application program that was programed in a different programming language than the transmitting computer 110. In each of these cases, the data structures/objects used on the receiving computer 160 would be the same data structures/objects used by the transmitting computer 110.

FIG. 1 also shows XML data 124 being held in storage 120. As explained below, one of the advantages of the present invention is the ability to convert between in-memory data 132 for program attributes and human-readable (or XML) data 124.

### Data Schema 200

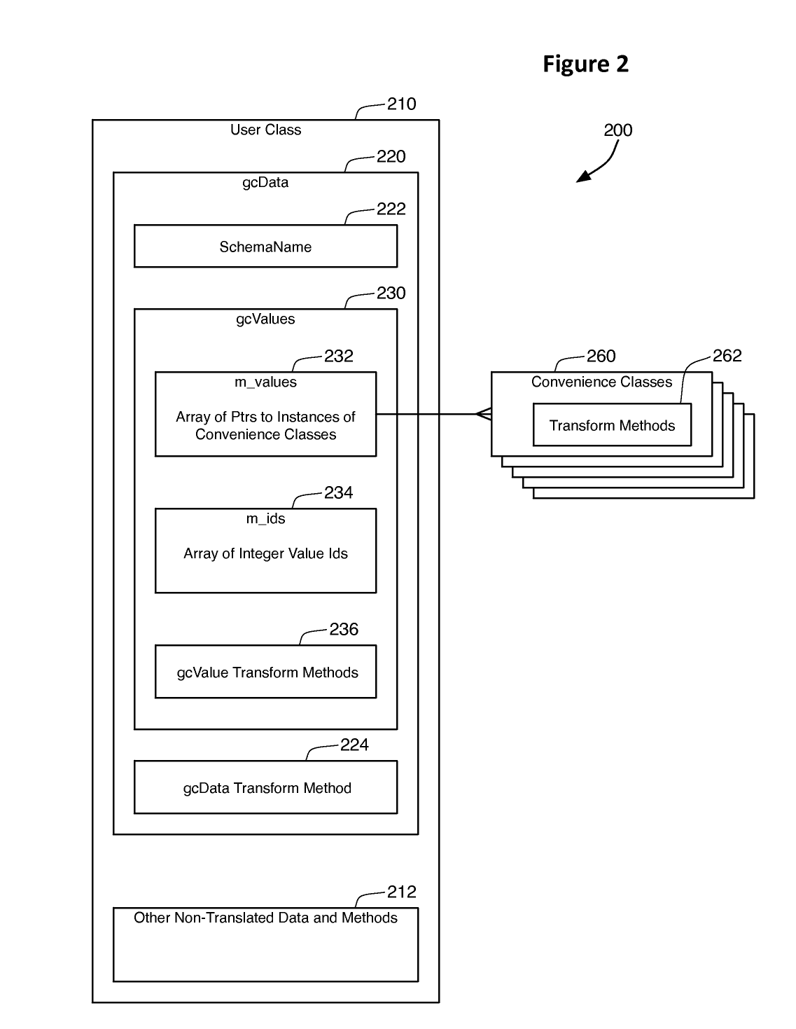

In one embodiment, the programming code 122 that defines the object data 132 for the transmitting computer must define the objects according to a particular data schema 200, which is shown in FIG. 2.

Data and metadata are held within a recursive and hierarchical set of convenience classes 260. A foundation class, called gcValueBase, is the base for each convenience class. One possible version of the gcValueBase class definition (written in Java) is shown in Table A below. In this embodiment, there are 23 types of convenience classes as shown in Table B. These convenience classes are each identified by a unique gcType numerical identifier, and can be characterized as follows:
Primitive values (hold one value of a particular primitive type): STRING, INTEGER, BYTE, LONG, FLOAT, DOUBLE, BOOLEAN, ENUM, TIMESTAMP
Array values (hold an array of a single type of primitive): STRING_ARRAY, INTEGER_ARRAY, BYTE_ARRAY, LONG_ARRAY, FLOAT_ARRAY, DOUBLE_ARRAY, BOOLEAN_ARRAY, ENUM_ARRAY, TIMESTAMP_ARRAY
Serial (holds one serial specification): SERIAL
gcValues (holds an array of pointers to convenience class instances): VALUES
gcData (holds a SchemaName and a gcValues class): DATA
List of data containers (holds an array of pointers to gcData classes): DATA_LIST, DATA_ARRAY
   Each of these convenience class types are named in one embodiment by adding the letters “gc” to the above type and by adding the word “Value” or “Array” at the end. For example, the STRING convenience class is named “gcStringValue,” while the TIMESTAMP_ARRAY convenience class is named “gcTimeStampArray.” This is seen more clearly in Table C. The convenience class gcValues 230 is defined to allow a plurality of different data types to be defined in a single class. The convenience class gcData 220 defines a data schema, and incorporates a schema name 222 and one instance of a gcValues class 230, as shown in FIG. 2.

The attribute m_type in the gcValueBase class definition holds an ordinal identifying the gcType. This identifies the type or kind of an instance of a convenience class so that a pointer to gcValueBase can be recast into a pointer to a particular convenience class.

As shown in FIG. 2, a user defines their class 210 utilizing a single gcData 220 convenience class. This gcData class 220 is an abstract class that holds the data and metadata for a particular user defined class 210. A pointer to gcData 220 represents a complete logical piece of data that can be transformed between formats by the described embodiment of the present invention. It holds a SchemaName 222 used to correlate the defining class with a generated text or serial format. As shown in FIG. 2, class gcData 220 includes both the schema name 222 and an embedded instance of class gcValues 230. The gcData class 220 also includes a transform method 224 that is programmed to transform the data elements defined by the gcValues class into human-readable XML text and to a serial data stream. Table D below shows the attributes and method signatures for gcData.

As explained above, the gcValues class 230 is a convenience class that holds a set of values that are pointers to convenience class instances 260. This is shown schematically in FIG. 2 using crows feet notation by the link between the m_values array 232 and the convenience classes 260. Each value class instance is added to gcValues during initialization of the metadata by a defining user class. Remembering that each convenience class is based on the gcValueBase class, each value pointer in m_values 232 is directed to a gcValueBase and is recast to a particular convenience class as indicated by gcType.

The m_ids array 234 in the gcValues class 230 is an array that acts in parallel with the m_values array 232. The m_ids array 234 is identical in size to the m_values array 232 and contains integer values that serve as the “id” numbers for each value in the gcValues class 230. In this way, every value has a unique identifier, which is used during serial data transformations as described below.

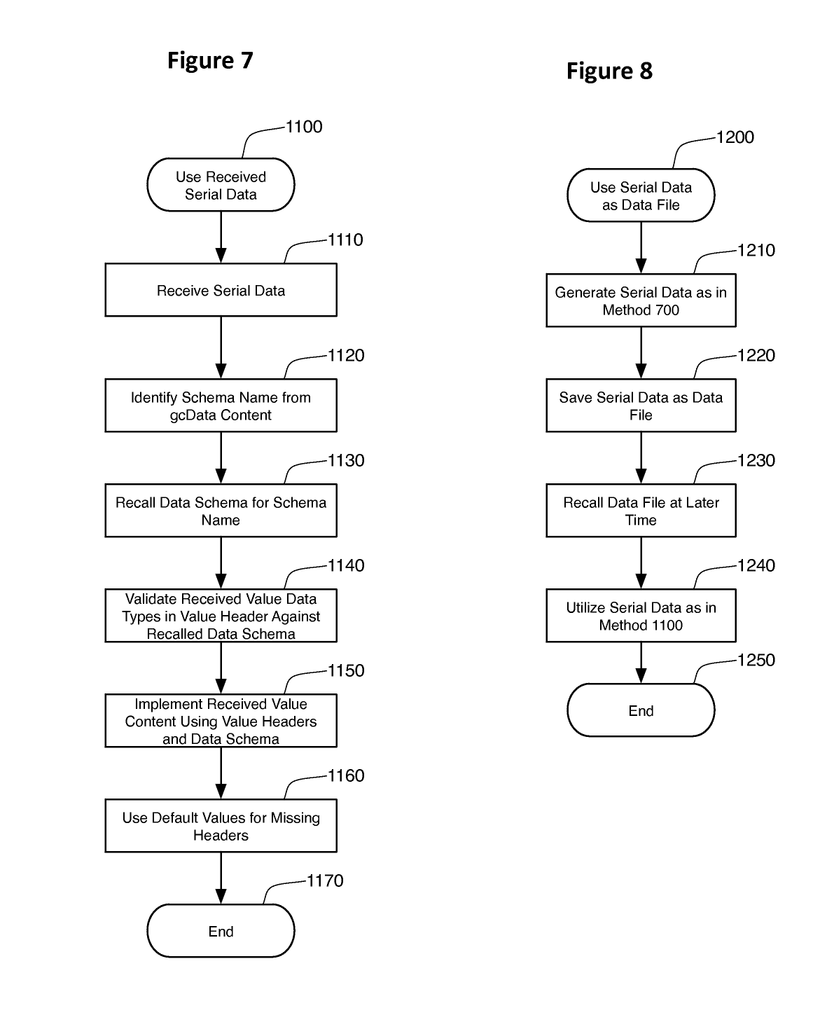

Class gcValues 230 also provides the transform algorithms 236 for each primitive data type such as byte, integer, string, etc. These transform methods are described below in connection with FIGS. 7-13.

Table E shows the attributes and method signatures for gcValues. As both gcData and gcValues are themselves convenience classes, the data structured defined by a gcData class 220 (consisting of one or more convenience classes 260 pointed to by the m_values array 232 in the gcValues class 230) can be recursive in that it can be based upon other gcData and gcValue classes.

### Other Defined Classes 700

Each complex data convenience class is based on gcContainerBase and provides a to-text transform for the data and meta that it contains. Table F shows the attributes and method signatures for gcContainerBase. The gcContainerBase class includes transform methods necessary to convert the in-memory data of the complex convenience class into serial data or human-readable text. In the preferred embodiment, the complex data convenience classes extend gcContainerBase and include the actual programming in those transformation methods required to transform the data held be that convenience class.

Class gcSchemaToClassMap is a simple class that holds a hashmap of schemaName to a pointer of a gcData instance. Table G shows the attributes and method signatures for gcSchemaToClassMap. A map is used by an infrastructure during transformation to find a gcData class instance corresponding to a schemaName.

Class gcDataArray is a convenience class that holds a set of pointers to gcData instances. Table H shows the attributes and method signatures for gcDataArray. It includes a gcSchemaToClassMap for use during format transformation.

Class gcIntegerValue is a convenience class that holds one primitive value of type int. Table I shows the attributes and method signatures for gcIntegerValue. Similar classes are defined for each primitive data type.

Class gcSerialValue is a convenience class that holds one serial specification. Table J shows the attributes and method signatures for gcSerialValue. This allows a serial specification to be embedded within a gcData instance.

Class gcDataList is a convenience class that holds a set of pointers to gcData instances. Table K shows the attributes and method signatures for gcDataList. This class differs from gcDataArray in that a delete of an entry is performed in two steps. The first step marks an entry for delete. The second step removes any entries marked for delete. This allows a second program on another system to participate in and know about a delete of an entry by a first program.

Class gcConvert has methods to transform data content between formats. Table L shows the method signatures for gcConvert. The serial to class transformation starts by obtaining a schemaName from the serial format. It maps the schemaName to a corresponding gcData class that has the current values initialized to default values. The conversion walks through the fields within the serial format and locates the corresponding convenience class instance. The serial data is transformed from serial format and inserted into the class instance.

### Data Transmission Method 700

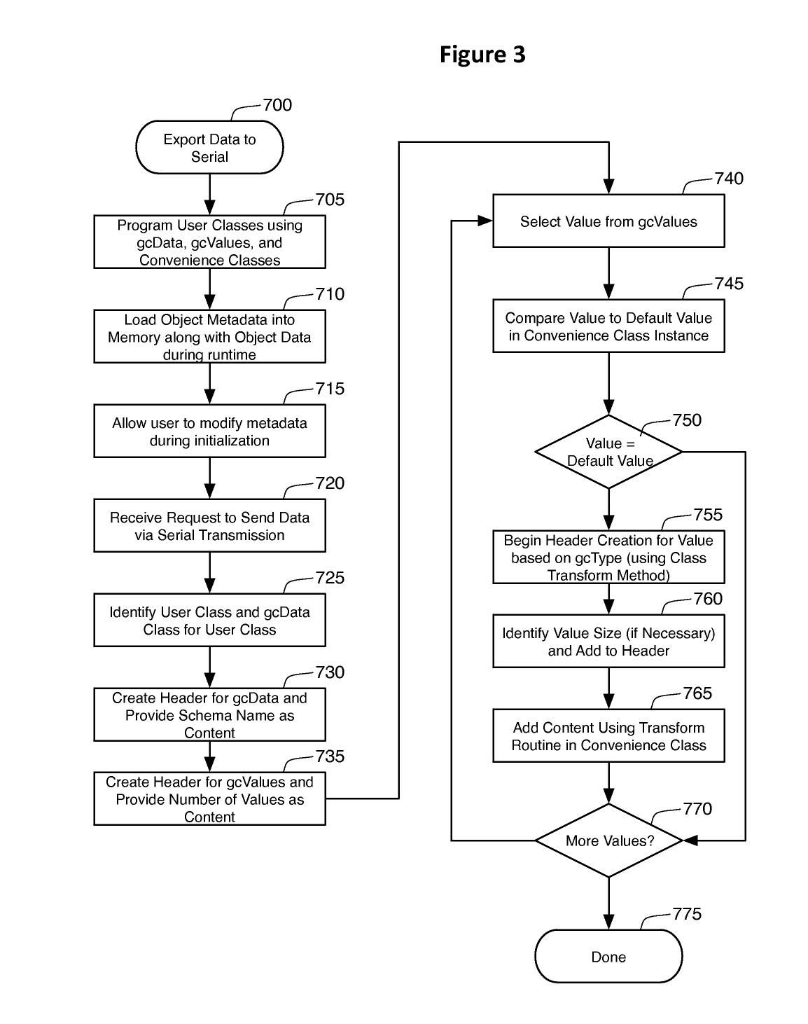

FIG. 3 shows a method 700 for transmitting object data 132 into serial format for transmission from the transmitting computer 110 to the receiving computer 160. The method requires that a programmer implement their object definitions using the structure 200 described above. In particular, step 705 of method 700 requires that a programmer define user classes that are to be transmitted via the serial communication path using a gcData class. The gcData class 220 contains a SchemaName 222 and an instance of a gcValues class 230. The gcValues class 230 defines all of the data that will be serially transmitted in the user class 210 as instances of one or more convenience classes 260. These convenience classes 260 each include methods for accessing their data (or rely on methods for primitive classes held in the gcValues class 230) and also define default values for the data represented by the convenience class.

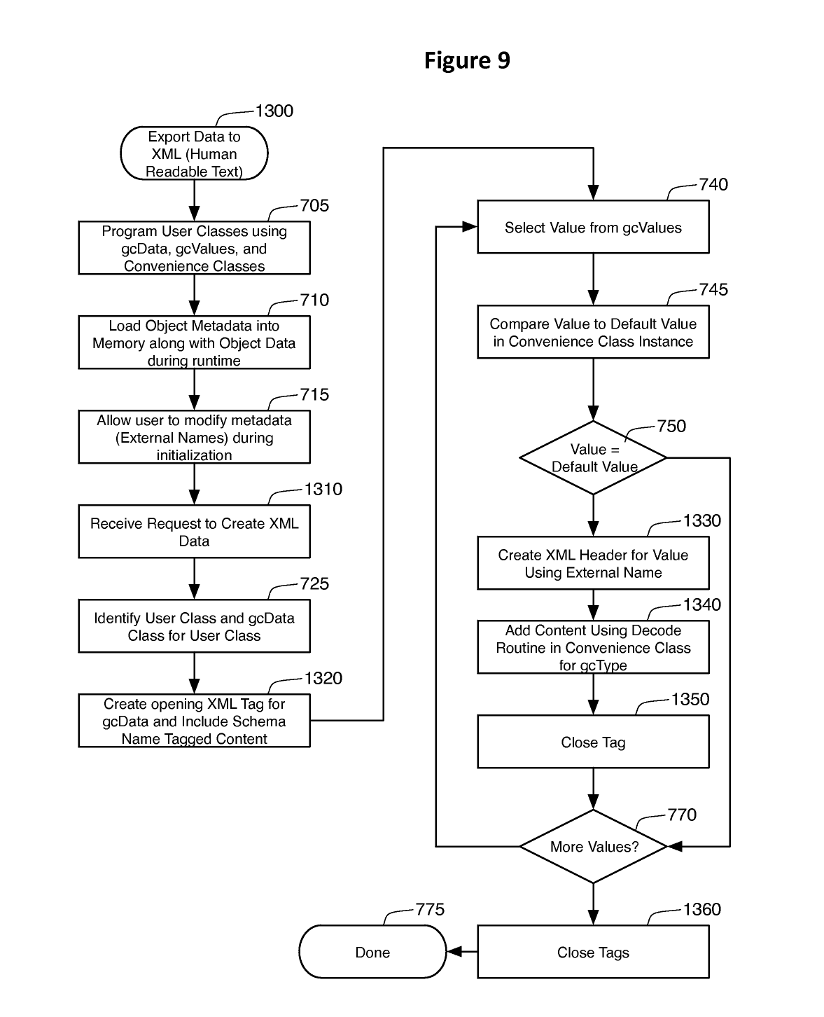

Step 710 occurs when the program code 122 is running on the processor 112. When this occurs, the processor 112 ensures the presence of both the object metadata 134 (defined by user class 210 and gcData 220) along with the actual object data 132 in RAM memory 130. By keeping the metadata 134 in RAM 130, this embodiment allows for the possibility that program code 122 will alter various aspects of the metadata 134 during class initialization. This is particularly useful during XML conversion (described below in connection with FIG. 9), as the program code can alter the external variable name during class initialization to make the resulting XML more readable. This occurs at step 715.

At step 720, the transmitting computer 110 receives a request to transmit the object data 132 to the receiving computer 160 via network 150. At step 725, the processor 112 identifies the user class 210 associated with each object 132 to be transmitted. In most cases, the request to transmit the object data received in step 720 will directly identify the user class 210 that will be transmitted. In FIG. 3, only a single class 210 is shown being transmitted. From the user class 210, the gcData class 220 and the gcValues class 230 for this data 132 are also identified. This metadata 134 is taken from RAM 130, and exists as modified by step 715.

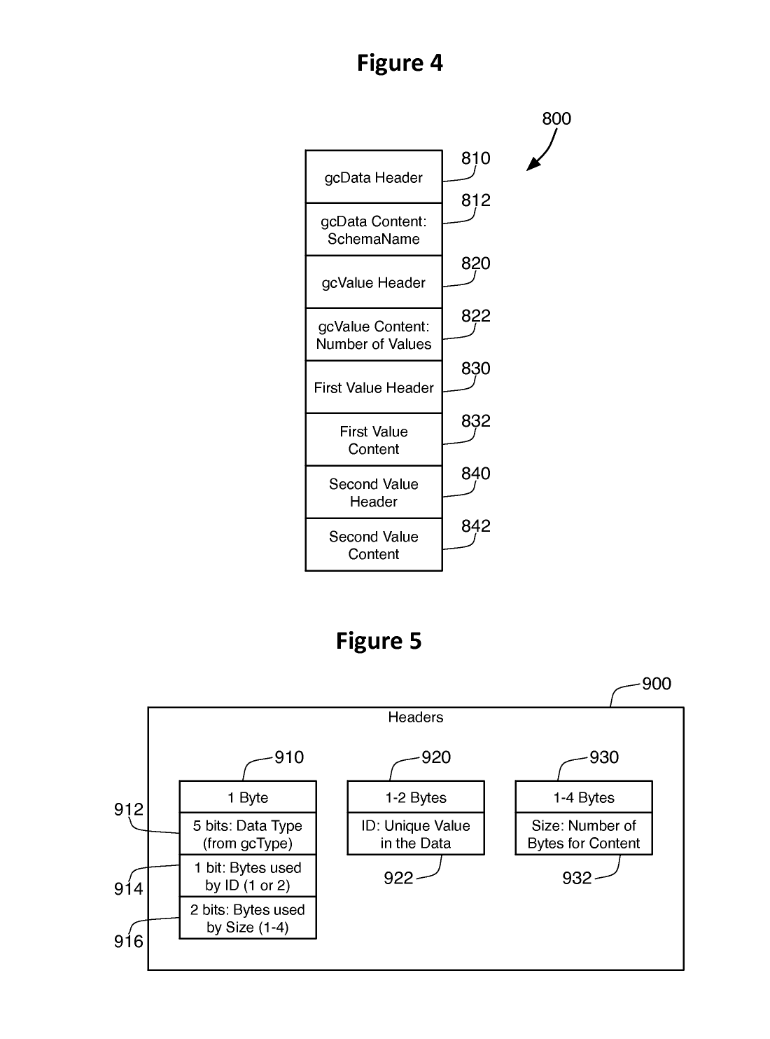

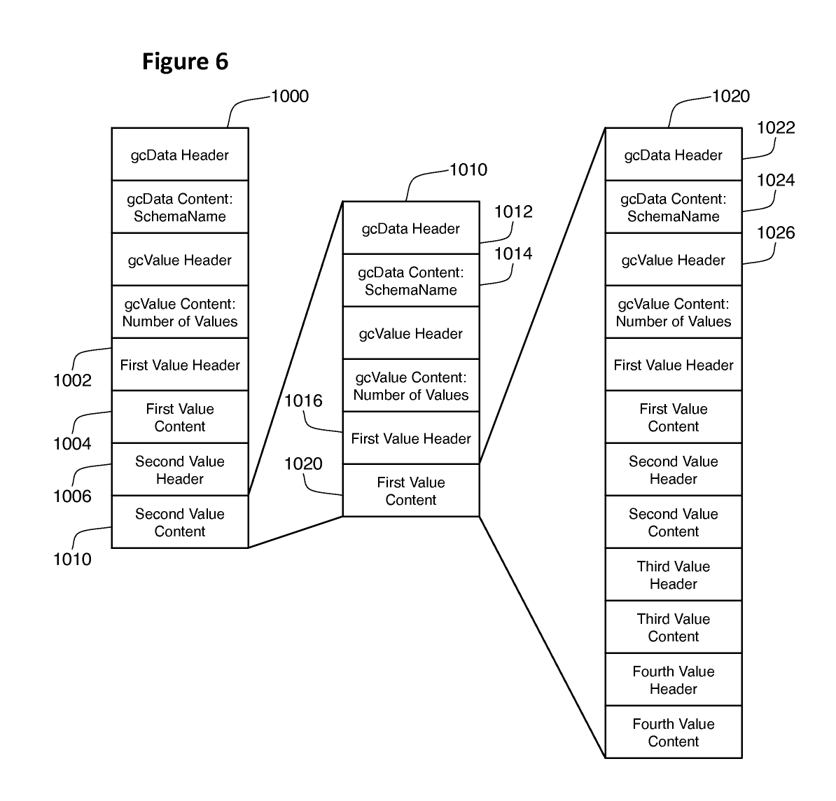

Once the metadata 134 has been identified for the data 132, the process of constructing the serial transmission will begin. The stream of bits in this transmission is represented schematically in FIG. 4. All of the data in serial data 800 is presented in simple header/content pairs. Each serial stream will start with a header 810 for gcData, and then content for the gcData 812. The stream 800 then continues on with a header 820 and content 822 for the gcValue class 230. The stream 800 then includes the real data 132 for the user class 210 by including the values in the convenience class instances 260 pointed to by the gcValues class 230. Each value starts with a header 830, 840, and a value 832, 842.

At step 730, the method 700 creates a header 810 for the gcData class 220 that defines this object. This header 810, like all the other headers 820, 830, 840 in the serial data stream 800, utilizes the header format 900 shown in FIG. 5. Each header starts with a first byte 910 which contains five bits 912 that define the Data Type in the form of a gcType numerical identifier as described above. For the gcData Header, for instance, one embodiment defines number “21” to indicate that this is a header for a gcData object. The next bit 914 defines the size of the ID field 920 in the header. The ID field 920 contains a unique identifier 922 for the value within the context of this data class. The ID field 920 can be either one or two bytes in size, as is indicated by bit 914. The first byte of the header 812 concludes with two bits 916 that define the number of bytes in the Size field 930. The size field 930 of the headers indicates the size in number of bytes 932 of the content for this class. The size field 930 itself can use 1-4 bytes. In the context of gcData Header 810, the ID field 920 is only a single byte. The size field 930 depends upon the size of the gcData content 812. For the gcData class 220, the only content is the SchemaName 222. The ID field 920 will contain an ID for the gcData, and the size field 930 will indicate the number of bytes used to transmit the Schema name 222. Step 730 concludes by adding the schema name 222 as the content 812 that follows the gcData header 810.

At step 735, a header is created for the gcValues class 230 using the same header format 900 that was used for the gcData header 810. The gcType number for the gcValues class (for instance, “20”) is provided at location 912. A unique identifier is provided at byte(s) 920, and the number of bytes used for the gcValues content 822 is indicated at 930. In one embodiment, the gcValues content 822 is a simple count of the number of convenience classes 260 pointed to by the gcValues class 230 (or, if default values are not included in the serial data stream, the gcValues content 822 is the number of non-default convenience classes 260 included within the data stream). In an alternative embodiment, this count can be placed directly in the gcValues header 820 in place of the size field 932. This would allow a number up to four bytes long, which would be sufficient for even the most complex data structures. In this alternative embodiment, no gcValues content 822 would be included in the data stream 800, and the gcValue header 820 would be followed by the header for the first real data value 830.

After the gcValues header 820 (and any gcValues content 822) is added to the data stream in step 735, the method 700 continues at step 740 by selecting the first value class 260 pointed to by the gcValues class 230. This first value may be of any of the primitive types described above, including integer, string, boolean, or string array. Furthermore, this first value may in fact be another gcValues class or even a gcData class.

Each instantiation of the convenience classes 260 includes an indication of the default value for that instantiation. At step 745, the method 700 compares the current value for that class 260 in the object data 132 to this default value. If step 750 determines that the current value is the same as the default value, then the method 700 will refrain from sending any data relating to this class 260. The receiving computer 160 is responsible for analyzing the received serial data stream 800 and determining that information for an expected class 260 is not found in the data stream 800. In these cases, the receiving computer 160 will instantiate that class 260 using the default value, so that the object data 182 at the receiving computer 160 will include this value even though the value was not found in the serial data stream 800 received from the transmitting computer. This is possible only because the data schema 172 for the gcData class 220 being transmitted is accessible to the receiving computer 160.

When step 750 determines that the current value of the data (or “attribute”) is not the default value defined in the class 260, the method 700 must include this data in the data stream 800. At step 755, the method 700 creates a data header 830 for this data based on the convenience class 260 definition for that data. This header 830 will again follow header format 900 and will start with a five bit gcData type number 912. This number 912 will inform the recipient computer 160 of the data's type (Boolean, string array, or gcValues, for instance). The ID value 922 will uniquely identify this value for this particular gcData class 220. Finally, the size field 932 will inform the recipient computer 160 of the number of bytes in the content 832. Because this number can vary depending on the current value in the object data 132, step 760 determines the appropriate size for this data so that the size header values 916, 932 can be properly set.

At step 765, the data content 832 is then added to the data stream. The conversion of an attribute value as stored in memory as object data 132 into serial content 832 inside the data stream is not always a trivial exercise. One of the primary benefits of using the convenience classes 260 for all data in a user class 210 (or at least for all data that is to be available for transformation under the present invention) is that the convenience classes can contain the necessary methods or programming to conduct this transformation. In the preferred embodiment, the transformation for all of the primitive types (integer, Boolean, string, etc.) are located directly within the gcValues class 230. When it is necessary to transform a primitive value in an attribute/convenience class pointed to by m_values 232, the transformation method for that primitive type in the gcValues class 230 can transform that value. For instance, if the current attribute is a “gcString” convenience class, the transformation method for the string primitive type in the gcValues class 230 will be used to populate the first value content 832.

As explained above, more complex data types (comprised of an organization of more primitive type attributes) are generally formed using the gcContainerBase class. The complex convenience classes that extend the gcContainer Base class contain the methods that provides for the transformation of complex data classes/structures. This method helps traverse the structure of the complex data class, and will call the primitive transformation methods in the gcValues class when necessary to extract a primitive component of the complex data class.

In the preferred embodiment, the transformation method will create not only the content field 832 for a data value/attribute, but also the value header 830 for that data value/attribute. This allows the creation of any value header/content pair in the serial data stream 800 to be automatically generated simply by calling the pre-existing transformation algorithm in the convenience class for that attribute.

In cases where the convenience class 260 is itself a complex data structure, such as a string array, step 755 will create the header 830 for that structure. The data type 912 will indicate the type of data contained by this structure by providing the gcType for this construct (e.g., gcString for a string array). In some embodiments, the content 832 for this complex data structure could indicate the number of elements in the structure, such as the number of strings in a string array. In the preferred embodiment, the number of elements in the structure will be inserted directly in the size field 932 in the value header 830. When implemented in this manner, the “content” field 832 in the data stream for these types of complex data structures would be used to present the headers and content for the individual elements of this complex data structure. In the case of an array of strings, each string in the array would have its own header and content field.

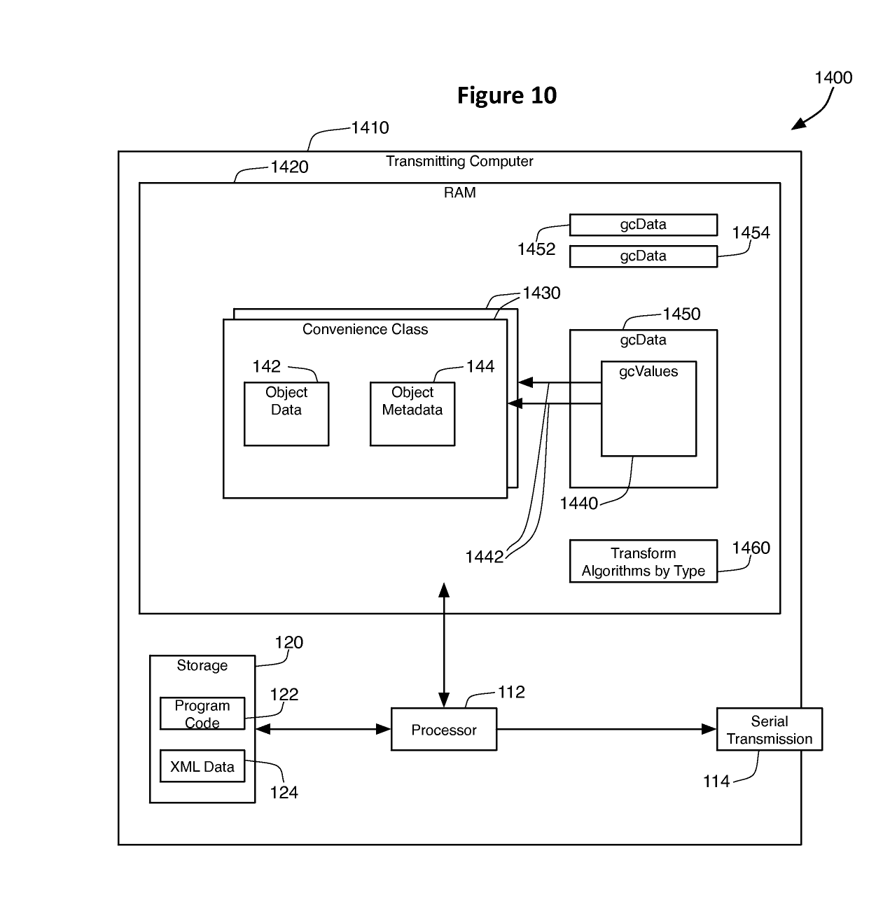

The content 832 of a complex data structure might also include other complex data structures. This can be accomplished in a recursive manner, allowing (for instance) strings of gcData values, with each gcData value also containing strings of other gcData values. This is seen schematically in FIG. 10 in which a serial stream 1000 for a first gcData class is shown. This first gcData class contains a gcValue class that links to two values. The first value 1002 might be a primitive convenience class, such as a long integer, and therefore can be inserted into the serial stream 1000 with a simple first value header 1002 and first value content 1004. The second value, however, is itself a gcData class. This is indicated in the value header 1006 for this second value. The second value content 1010 is itself an entire gcData serial stream 1010 with, for instance, its own gcData Header 1012 and its own gcData content 1014 identifying the schema name for this gcData stream 1010. This stream 1010 contains only a single value, which is itself another gcData class. This is identified in the first value header 1016 of the second stream 1010. The first value content 1020 for the second serial stream is the complete serial stream 1020 for the third gcData class. The third serial stream 1020 for the third gcData class again repeats the gcData header 1022 and gcData content 1024, indicates that there are four values in the gcValue content 1028 (or directly in the gcValue header 1026), and then presents the header and content for each of these values.

Step 770 is reached after the data content 832 is added to the data stream 800, or after step 750 determines that the value for the current convenience class 260 is the same as the default value. Step 770 determines whether the gcValues class 230 is linked to more convenience classes 260. If so, the method continues at step 740 by selecting the next convenience class 260 linked to by the gcValues class 230. FIG. 4 shows that a second value 842 and header 840 have been added to this data stream 800 in this manner. If step 770 determines that all of the convenience classes 260 linked to by the gcValues class 230 have been handled, the method 700 ends at step 775. Note that there is no need to provide any ending or closing bits to the data stream 800, as the appropriate size of each elements have been precisely defined in the headers 810, 820, 830, 840.

In one embodiment, the programming to perform steps 730 to 775 of method 700 are found within the gcData 220, gcValues 230, and the convenience classes 260 that define the data construct that is being transmitted in the serial data stream. The gcData class 220 contains a transformation method 224 that creates the gcData header 810 and content/schema name 812, and then calls the transformation algorithm in the contained gcValues class 230. The transform method 236 in the gcValues class 230 is responsible for stepping through each attribute/convenience class 260 pointed to by its m_values array 232. In one embodiment, each convenience class 260 contains its own transform algorithm that creates its value header 830 and its value content 832 for that attribute. The gcValues transform method 236 in this embodiment would simply call the appropriate transform method in the linked-to convenience classes 260, knowing that each of these methods would properly create the header/content pairs 830/832 (or 840/842) for all of the attributes of the gcData construct 220. In another embodiment, the gcValue transform algorithm 236 contains programming to handle the creation of the header/content pairs for all primitive value convenience classes 260 (such as integer, byte, long, float, etc.). Complex data structures are based on the gcContainer class, and would contain transform methods for these complex structures.

In yet another embodiment, the entire algorithm for performing steps 730-775 would be found in a separate class. In the tables, this separate class is called gcConvert. The gcConvert algorithm would be instantiated for every program that implements the class structure shown in FIG. 2. This would give every gcData instance 220 the ability to call the transform algorithm within the gcConvert instance, which would then create the data stream 800 based on the data within the gcData class 220, the gcValues class 230, and the linked to convenience classes 260.

### Use of Serial Data

FIG. 7 shows a method 1100 for using the received serial data. In the preferred embodiment, a receiving computer, such as computer 160 shown in FIG. 1, will receive data at step 1110. This data will have been transmitted using method 700 described above. At step 1120, the receiving computer 160 will identify the SchemaName from the gcData Content 812 field found in the beginning of the serial stream 800. Using this name, the receiving computer 160 can recall the data scheme 172 for this name from its storage/memory 170 at step 1130. The data scheme might also be found in the metadata 184 in the computer's RAM 180. The scheme 172 can then be used to identify and verify the gcValue information and each value contained in the gcValues class. For example, the header 900 for each value in the data stream 800 includes an identifier for the value 914 and a data type 912 for that value. Once the identifier 914 is known, the receiving computer could simply recall the data type from the stored data schema 172. In one embodiment, the receiving computer analyzes the data type 912 from each value header and compares this to the expected value in the stored data schema 172. If there is a mismatch, the receiving computer will know that its stored data schema is out of data or otherwise corrupted. This comparison takes place at step 1140.

At step 1150, the receiving computer reconstructs the object data 182 in its RAM memory 180 using the received data 800. In some embodiments, the transmitting computer 110 will not send any data in the data stream 800 if the current value for that variable is the default value. This means that the receiving computer 160 must determine whether any values in the stored data schema 172 have been skipped in the incoming data stream 800. If so, the receiving computer will use the default value found in the stored data schema 172 to populate the data for that variable in object data 182. This takes place in step 1160. At this point, the method 1100 ends at step 1170.

FIG. 8 shows a method in which the serial data stream 800 is stored as a data file for later use. In this method, the data stream 800 is created according to the steps of method 700 at step 1210. Instead of sending serial data 800 over a network 150, however, the data 800 is saved as a data file in step 1220. This allows the data to be stored in a stable manner. The saved data file can then be recalled at a later time 1230, either by the same computer 110 that created this data file or by a different computer (such as computer 160). This is done at step 1230. The computer that reads this data file then uses method 1100 to restore the content of the file into memory 180. This takes place at step 1240, and the method then ends at step 1250.

### XML Data

FIG. 9 shows a method 1300 that utilizes the present invention to encode live data 132 in memory 130 into human readable text. The dominant form of human readable text for data at this time is XML. Consequently, for the purposes of this disclosure, human readable text will be described in the context of XML. XML will typically embed attribute values between tags identifying the attribute, such as <attribute-name>XXX-Value-XXX</attribute-name>. Method 1300 is designed to allow any attribute data 132 in memory to be exported into human-readable XML without any specific transformation programming being needed in the user class 210. Instead, method 1300 uses only the methods found in the convenience classes on which the user class 210 was based.

This method 1300 is very similar to the method 700 used to export attribute data 132 in memory to a serial stream 800. The difference is that the end result is a formatted XML text data instead of serial data, with the XML text data being organized with traditional XML tags as opposed to serial header/value pairs. Because of the similarities between method 700 and method 1300, method 1300 is shown in FIG. 9 with identical method steps using the figure numbers of FIG. 3. The method begins with the user defining user classes using the gcData 220, gcValues 230, and other convenience classes 260 (step 705), loading the metadata into memory along with the object data (step 710), and allowing the user to modify external variable names during class initialization (step 715). At step 1310, the method receives a request to create XML data for the attribute data 132 for a particular user class 210 in memory 130. Step 725 then identifies the gcData class upon which the User class was based.

Step 1320 then begins the actual creation of the human-readable XML text. As was the case in connection with method 700, the steps from 1320 to step 1380 can be performed by the transform methods with the gcData class 220, the gcValues class 230, and the convenience classes 260. The transform method for each convenience class 260 can be responsible for creating its own opening and closing tags and for transforming its data into human-readable text for the content of the tagged item. Due to the recursive nature of the data structure 200, the content of a class may be one or more other convenience classes, and may be created simply by calling the appropriate transform method of those other convenience classes.

Step 1320 creates the XML tags for gcData class 220. XML tags will have opening and closing tags. In the flowchart shown in FIG. 9, the closing tags are created at a separate step 1350, with opening tags being created first, content existing within the tag being created second, and closing tags being created last. However, depending on the manner in which the XML text is created and maintained in memory, it is possible to create the opening and closing tags together and then insert the content within the tags after the fact. In method 1300, the opening tags for the gcData class are created in step 1320 by the gcData transform method 224. This involves determining the eternal name for the gcData (which may have been altered in step 715) and using that name for the opening tag in the XML document. Next the schema name is inserted, which may look like <schema>schema-name</schema>.

The gcData transform method 224 then calls the gcValues transform method 236, which is responsible for walking through all of the attributes/convenience classes 260 associated with this gcData class 220. At step 740 the first value from the m_values list 232 maintained by the gcValues class 230 is selected. This attribute value is compared with the known default value in step 745, and step 750 determines whether the value has been changed from the default value. If so, it will be necessary to add appropriate XML tags and this value to the created XML text. As was the case with the serial transformation method 700, the methods within the convenience classes can be used created these tags and insert the appropriate value within the XML. Alternatively, in the case of primitive convenience classes, the programming to create the tagged value can be part of the gcValues transform method 236. In other embodiments, step 750 will be skipped and all values, including default values, will be included in the XML text.

At step 1330, the method 1300 creates an XML header for this value. This XML tag can use the external name assigned for the initialized instance of this convenience class (modified as desired in step 715) within the XML tag in order to ease the human readability of the generated text. In this way, the programmer can control the labels used to identify each attribute value within the XML text. At step 1340, the actual content for each attribute value is added to the human-readable XML text. The value inserted at this step can be of any convenience class, including complex convenience classes such as another gcValues, gcData, or even a string of gcData values. Thus the created XML may represent complex, recursive combinations of data types and values, just as described above in connection with FIG. 10 in the context of serial transformations. The closing XML tag for the value is then added to the XML tag at step 1350, and more values are handled at step 770. Once all values are handled, closing tags for the gcData classes are added to the created XML text at step 1360, and the method ends at 775.

The preferred embodiment also includes an algorithm to convert XML data back into in-memory data. This will be accomplished using an algorithm extremely similar to method 1100, except that the method will operate on an XML file rather than a received data stream.

### Alternatives

FIG. 10 shows the system 100 of FIG. 1 in a slightly modified manner as system 1400. In this system 1400, a transmitting computer 1410 still has object data 142 and object metadata 144 in its RAM 1420. However, in system 1400, the object data 142 and the object metadata 144 are shown together within a convenience class 1430. Every instance of real data (at least, every instance that is designed to be transformed using the present invention) is found within a separate instance of a convenience class 1430. As shown in FIG. 10, a plurality of convenience classes 140 are linked together by a gcValues class 1440, which is part of a gcData class 1450. In effect, the gcValues class 1440 contains a list in the form of links 1442 to all convenience classes containing attributes for the data structure defined by the gcData class 1450. While this representation of data 142, 144 within computer 1410 is completely consistent with the representation shown in connection with system 100 above, the representation of FIG. 10 explicitly shows the object data 142 and the object metadata 144 for each attribute being maintained within the class structure described above.

The RAM 1420 also contains a variety of transform algorithms 1460. In the above description, most of these algorithms were embedded in the class definitions for gcData 220, gcValues 230 (perhaps used for primitive attributes), or the convenience classes themselves. In system 1400, the algorithms may exist within these class structures, or outside these structures (such as in a gcConvert class instance).

FIG. 10 does provide additional clarity on one key aspect of the present invention. That is, for any data structure 1450 containing real data 142 in memory 1420, the system 1400 maintains a list of all attributes in the data structure 1450 in memory 1420. When multiple gcData defined instances of user classes coexist in memory 1420 at any given time (such as gcData instances 1452, 1454), each instance contains their own list (defined through their gcValues) to their own attributes. These lists allows the structures to immediately identify all attributes (including both their real world value and their data type) that constitute the structure. It is this list of attributes that allows methods 700 and 1300 to walk through all attributes in a data structure in steps 750-770. Furthermore, it is the fact that the list identifies a transform algorithm for this attribute based on its immediately identifiable data type that allows the methods to add the value of the attribute to the data stream 800 or the XML file without any custom programming on the part of the programmer.

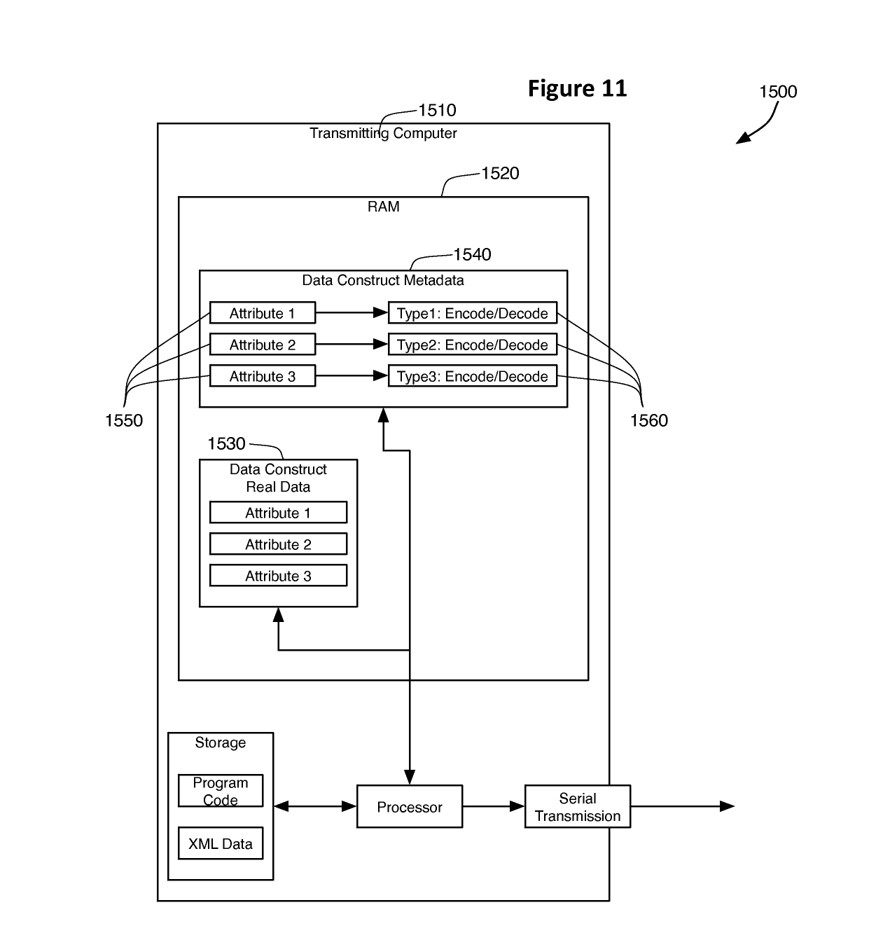

This construct is generalized in computer 1510 shown in the system 1500 of FIG. 11. This computer 1510 has similar elements to computers 110 and 1410, including RAM 1520. This RAM 1520 includes at least one data construct with real data 1530. This data construct may be an object in an object oriented programming environment, or may be another type of complex data structure in other programming environments. In this case, the data construct real data 1530 includes three attributes. For the purpose of this example, each of these attributes will be considered to have a different type, namely type1, type2, and type 3. The RAM also contains metadata 1540 that describes this same data construct. This metadata 1540 includes a list 1550 of all of the attributes containing real data 1530 for this data construct. This list 1550 includes an indication of a data type 1560 for each attribute in the list 1550. This type 1560 information is then used to identify transform algorithms appropriate for this data type. This allows the system 1500 to utilize the methods 700, 1100, 1200, and 1300 to transform real data in the data structure between live, in-RAM data and a serial stream 800 or XML data.

This system 1500 can be implemented as a feature within a class-based (object oriented) compiler or interpreter. In these embodiments, the metadata 1540 is held within memory 1520 separate from class instance attributes 1530. In this metadata 1540, the compiler or interpreter maintains a list 1550 of attributes for each data construct 1530 existing in memory 1520. This list links to a data type that can be used to identify a particular format conversion method 1560 that the compiler provides for that data type. Alternatively, each entry in the list 1550 can link directly to the transform method 1560 need to transform that data attribute 1550. One advantage of this implementation is that only one copy of metadata 1540 is held within memory 1520 for each class structure 1530, rather than requiring the use of convenience classes that hold metadata 134 for each attribute instance. Modification of metadata 1540 by a subsequent class, such as a changed external name, requires each such exception to also be held within memory. This alternative implementation substitutes convenience classes with a hidden representation of metadata 1540. The essence of the current innovation is unchanged in that metadata 1540, regardless of the method of specification or memory storage, guides the transformation of data content between data formats.

### EXAMPLES

Table M shows a vanilla Java class called uiColorSpec that holds the RGB specification for one color. Table N shows uiColorSpec which is uiColorSpec redefined to include metadata. An instance of uiColorSpec executes in three phases. The initialization phase sets up the convenience class instances and associated metadata. The data access phase supports get and set of data values held within the convenience class instances. The transformation phase uses the metadata to know how to transform data between formats. Table O shows the attributes that exist after initialization that are used by access and transformation phases.

Table P shows a data class written in Java that includes metadata used for both serial and text data conversions. The programDefinition class contains program name, type of program and class reference for one program as specified by a system admin.

Attributes to be converted must be explicitly identified as shown in Table P lines 23 and 27. Furthermore, attributes can be intentionally omitted so that they are only used by a local class instance and are not converted into text or serial formats.

The systemConfig class (not shown) contains configuration information specified by a system admin for a multiple computer and multiple program software system. The programDefinition class shown in Table P is used for each program defined within systemConfig. Tables Q thru S show various data conversion aspects of programDefinition as embedded within systemConfig.

Table Q shows the text automatically generated from the class in diagram Q when an admin wants to see the possible values contained in a class along with any default value.

Table R shows the text an admin uses to populate data into systemConfig via a process called import. Diagram R also shows the text generated as the result of an export of a systemConfig file persisted in serial format.

Table S shows a hexadecimal representation of the serial within systemConfig associated with the other diagrams.

The following table identifies some of the mapping of information from a line in Table P into lines of Table, Q, R, and S. The infrastructure data conversion algorithm automatically performs this mapping as part of the algorithm when converting data between formats.

| | Tables: | | | |
|---|---|---|---|---|
| | P | Q | R | S |
| Lines: | 022 | 001 | 001 | n/a (programDefinition) |
| | 022 | 007 | 006 | n/a (programDefinition) |
| | 022 | 002 | 002 | 036 (sfPrgDef) |
| | 023 | 003 | 003 | n/a (name) |
| | 023 | 003 | n/a | n/a (“”) |
| | 023 | n/a | n/a | 037 (1) |
| | 023 | n/a | n/a | 037 (type of gcStringValue) |
| | 027 | 004 | 004 | n/a (programType) |
| | 027 | 004 | n/a | n/a (0 represents UNKNOWN) |
| | 027 | n/a | n/a | 037 (2) |
| | 027 | n/a | n/a | 037 (type of gcEnumValue) |
| | 029 | 004 | n/a | n/a (UNKNOWN represents default |
| | | | | of 0 from line 27) |

This pattern continues for Table P lines 30, 31, 32, 36, 40 and 42.

The method of finding lines in Table Q is as follows: The serial encoding algorithm uses UTF-8 representation for content of string values. The dataSchemaName (e.g. sfPrgDef) is also embedded within serial as UTF-8. For example, .sfHub is 2e 73 66 48 75 62 which matches content within Diagram T line 40. Note that lines 37 to 40 contain the string “nelson.eugene.serviceFrame.fred.hub.sfHub” which corresponds to line 5 of diagram S.

The exact serial encoding algorithm is similar to ASN.1 and can be found by examining the implementation of infrastructure class gcConvert. There is no need to publish the serial format in a standard as an instance of class gcConvert, within the appropriate language, is always used for data conversion.

The text encode and decode algorithm is similar to XML with an in-line parser. The implementation can be found by examining class gcConvert and generic container classes such as gcData and gcValues.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

TABLE A
gcValueBase attributes and methods

Class gcValueBase is an abstract class that serves as a base for a convenience class.
abstract public class gcValueBase
Boolean to indicate if class instance has been initialized.
private boolean m_initialized = false;
Ordinal value from gcType that indicates parent convenience class.
private gcType m_type;
External name used within text format to briefly identify meaning of data value.
private String m_name;
Boolean to indicate if value changed since last generation of data content in another
format.
private boolean m_valueChanged;
Pointer to class instance that is notified upon value change.
private gcChangeNotifyInterface m_notify;
Initialize class instance with provided type and external name.
void initValueSchema(gcType type, String name){ }
Force class tree extending this class to implement a reset method.
abstract public void reset( );
Set notify class pointer.
public void setChangeNotify(gcChangeNotifyInterface changeNotify){ }
Set external value name. Typically, used by a higher level user defined class to override
the external name set by a lower level class, e.g. Change uiColorSpec to foreground.
public void setValueName(String valueName){ }
Check if class instance is initialized.
public boolean isInitialized( ){ }
Get type of higher level convenience class.
public gcType getType( ){ }
Get external name used for value.
public String getValueName( ){ }
Check if value changed since last generation of data content into another format.
public boolean isValueChanged( ){ }
Set or reset value changed indication.
public void setValueChanged(boolean valueChanged){ }

TABLE B
gcType enumeration

public enum gcType
{
//Primitive values
STRING, INTEGER, BYTE, LONG, FLOAT, DOUBLE, BOOLEAN,
ENUM, TIMESTAMP,
//Array container of single type of primitive
STRING_ARRAY, INTEGER_ARRAY, BYTE_ARRAY,
LONG_ARRAY, FLOAT_ARRAY, DOUBLE_ARRAY,
BOOLEAN_ARRAY, ENUM_ARRAY, TIMESTAMP_ARRAY,
//Serial format of container instance
SERIAL,
//Container of any type of value
VALUES,
//Data Schema
DATA,
//List container of data container
DATA_LIST, DATA_ARRAY
}

TABLE C
convenience class names and purpose

gcStringValue - hold one String data value
gcIntegerValue - hold one int data value
gcByteValue - hold one byte data value
gcLongValue - hold one long data value
gcFloatValue - hold one float data value
gcDoubleValue - hold one double data value
gcBooleanValue - hold one bool data value
gcEnumValue - hold one integer value with mappings to an external
name per possible value
gcTimeStampValue - hold one time of day value
gcStringArray - hold an array of String values
gcIntegerArray - hold an array of int values
gcByteArray - hold an array of byte values
gcLongArray - hold an array of long values
gcFloatArray - hold an array of float values
gcDoubleArray - hold an array of double values
gcBooleanArray - hold an array of bool values
gcEnumArray - hold an array of enum values
gcTimeStampArray - hold an array of time of day values
gcSerialValue - hold one serial specification
gcValues - hold an array of pointers to convenience class instances
gcData - hold a schemaName and a gcValues class
gcDataList - hold an array of pointers to gcData based classes
gcDataArray - hold an array of pointers to gcData based classes

TABLE D
gcData attributes and methods

Class gcData is an abstract class that serves as a base for a user defined
class of a transformable data unit.
abstract public class gcData extends gcValues
The character set for utf8. Obtained once at initialization.
private static Charset m_utf8charset = null;
The schemaName used within a generated format to identify the creating
class.
private String m_schemaName;
The schemaName in utf8 format. Translated once at initialization of
schemaName.
private byte[ ] m_utf8SchemaName;
The text format line separator sequence obtained once at initialization.
private static String m_lineSeparator = null;
Force class extending gcData to implement a method that initializes an
instance with default values.
abstract public gcErrorResult initDefault( );
Initialize class instance with provided external name and schema name.
public void initSchema(String name, String schemaName){ }
Return utf8 character set used for translation of string content to and from
serial format.
public static Charset getUtf8charset( ){ }
Return text line separator sequence.
public static String getLineSeparator( ){ }
Instantiate and initialize a class based on gcData by a class reference.
Return created class pointer or information on encountered error.
public static gcData newClassByName(String classRef, gcErrorResult
errorInfo){ }
Generate text that shows data based on metadata held within class
instance.
public gcErrorResult toXML(StringBuilder xmlBuffer){ }
Generate text that shows default values and specifiable data based on
metadata held within class instance.
public void defaultsToXML(StringBuilder xmlBuffer){ }
Create new instance of class initialized with default values.
abstract public gcData newInstance( );

TABLE E
gcValues attributes and methods

Class gcValues is a convenience class that holds an array of pointers to convenience
classes containing transformable data and metadata.
public class gcValues extends gcContainerBase
Values is an array of pointers to gcValueBase contained within the inheritance tree of
each convenience class.
private ArrayList<gcValueBase> m_values = new ArrayList<gcValueBase>( );
ValueIds is a parallel array to values that holds the id used in the generated serial format
to identify the associated convenience class instance.
private ArrayList<Integer> m_valueIds = new ArrayList<Integer>( );
Initialize class instance with provided external name.
public void initValuesSchema(String name){ }
Generate error result that contains the indicated class name and previously used id.
public gcErrorResult idErr(String className, int id){ }
Reset each current value to its default value.
public void reset( ){ }
Set notify class pointer.
public void setChangeNotify(gcChangeNotifyInterface changeNotify){ }
Create gcStringValue class instance initialized to indicated metadata. Ensure id is unique.
Add class pointer to m_values array.
public gcStringValue createStringValue(String name, String defaultValue, int
id){ }
Create gcIntegerValue class instance initialized to indicated metadata. Ensure id is
unique. Add class pointer to m_values array.
public gcIntegerValue createIntegerValue(String name, int defaultValue, int
id){ }
Create gcByteValue class instance initialized to indicated metadata. Ensure id is unique.
Add class pointer to m_values array.
public gcByteValue createByteValue(String name, byte defaultValue, int id){ }
Create gcLongValue class instance initialized to indicated metadata. Ensure id is unique.
Add class pointer to m_values array.
public gcLongValue createLongValue(String name, long defaultValue, int id){ }
Create gcFloatValue class instance initialized to indicated metadata. Ensure id is unique.
Add class pointer to m_values array.
public gcFloatValue createFloatValue(String name, float defaultValue, int id){ }
Create gcDoubleValue class instance initialized to indicated metadata. Ensure id is
unique. Add class pointer to m_values array.
public gcDoubleValue createDoubleValue(String name, double defaultValue, int
id){ }
Create gcBooleanValue class instance initialized to indicated metadata. Ensure id is
unique. Add class pointer to m_values array.
public gcBooleanValue createBooleanValue(String name,
boolean defaultValue, int id){ }
Create gcEnumValue class instance initialized to indicated metadata. Ensure id is unique.
Add class pointer to m_values array.
public gcEnumValue createEnumValue(String name, int defaultValue,
gcEnumValue baseEnum, int id){ }
Create gcTimeStampValue class instance initialized to current time and indicated
metadata. Ensure id is unique. Add class pointer to m_values array.
public gcTimeStampValue createTimeStampValue(String name,
Timestamp defaultValue, int id){ }
Create gcSerialValue class instance initialized to indicated metadata. Ensure id is unique.
Add class pointer to m_values array.
public gcSerialValue createSerialValue(String name, int id){ }
Add gcContainerBase class instance to list of values. Ensure id is unique.
public boolean addContainer(gcContainerBase container, int id){ }
Set gcContainerBase class pointer into previously added values entry as identified by id.
public void setContainer(gcContainerBase container, int id){ }
Generate text that shows data based on metadata held within class instance.
public gcErrorResult toXML(StringBuilder xmlBuffer){ }
Generate text that shows default values and specifiable data based on metadata held
within class instance.
public void defaultsToXML(StringBuilder xmlBuffer){ }
Translate text containing special XML characters into proper escape sequence.
public static void encodeXMLText(String text, StringBuilder xmlBuffer){ }
Return values array pointing to gcValueBase.
public ArrayList<gcValueBase> getValues( ){ }
Return id array that corresponds to values array.
public ArrayList<Integer> getValueIds( ){ }

TABLE F
gcContainerBase methods

Class gcContainerBase is an abstract class that serves as a base for a
convenience class containing a complex set of data.
abstract public class gcContainerBase extends gcValueBase
Force class extending gcContainerBase to implement a method that
generates text from the held data values and metadata.
abstract public gcErrorResult toXML(StringBuilder xmlBuffer);
Force class extending gcContainerBase to implement a method that
generates text from the held default values and metadata.
abstract public void defaultsToXML(StringBuilder xmlBuffer);

TABLE G
gcSchemaToClassMap attributes and methods

Class gcSchemaToClassMap is a simple class used to map
SchemaName to a corresponding gcData instance.
public class gcSchemaToClassMap
Map of schemaName to corresponding gcData class instance.
private Map<String, gcData> m_schemaMap = new HashMap<String,
gcData>( );
Add all mappings from indicated map into the map held by this class.
public void addall(gcSchemaToClassMap schemaMap){ }
Add an entry to the schema map for indicated gcData class.
public void addMapping(gcData data){ }
Return schema map.
Map<String, gcData> getMap( ){ }
Find and return gcData class instance by indicated schema name.
public gcData getDataClass(String name){ }
Call method defaultsToXML( ) for every entry in the schema map.
public void defaultsToXML(StringBuilder xmlBuffer){ }

TABLE H
gcDataArray attributes and methods

Class gcDataArray is a convenience class that holds an array of pointers
to gcData classes.
public class gcDataArray extends gcContainerBase
Each pointer to gcData is held within dataArray.
private ArrayList<gcData> m_dataArray = new ArrayList<gcData>( );
This schema map contains all classes that can be used by an entry within
dataArray.
private gcSchemaToClassMap m_schemaMap;
Initialize class instance with provided external name.
public void initSchema(String name){ }
Set schema map to indicated map.
public void setSchemaToClassMap(gcSchemaToClassMap
schemaToClassMap){ }
Return schema map.
public gcSchemaToClassMap getSchemaToClassMap( ){ }
Add gcData pointer to dataArray.
public void add(gcData data){ }
Get gcData point at indicated index.
public gcData get(int index){ }
Return true if dataArray is empty.
public boolean isEmpty( ){ }
Remove entry at indicated index.
public gcData remove(int index){ }
Set dataArray to indicated array.
public void setArray(ArrayList<gcData> array){ }
Return dataArray of gcData pointers.
public ArrayList<gcData> getArray( ){ }
Reset dataArray to initial condition of empty.
public void reset( ){ }
Clear dataArray to initial condition of empty.
public void clear( ){ }
Place external name into text and call method toXML( ) for every entry
in the dataArray.
public gcErrorResult toXML(StringBuilder xmlBuffer){ }
Place external name into text and call method defaultsToXML( ) for every
entry in the dataArray.
public void defaultsToXML(StringBuilder xmlBuffer){ }

TABLE I
gcIntegerValue attributes and methods

Class gcIntegerValue is a convenience class that holds an int.
public class gcIntegerValue extends gcValueBase
Hold default value.
private int m_defaultValue;
Hold current value.
private int m_value;
Initialize class instance with provided external name and default value.
public void init(String name, int defaultValue){ }
Reset current value to default value.
public void reset( ){ }
Return current value.
public int getValue( ){ }
Set current value.
public void setValue(int value){ }
Return default value.
public int getDefaultValue( ){ }

TABLE J
gcSerialValue attributes and methods

Class gcSerialValue is a convenience class that holds a serial specification.
public class gcSerialValue extends gcValueBase
Hold a pointer to class gcSerialPackage (container of one or more Java
byteBuffer classes).
private gcSerialPackage m_serialPackage = null;
Hold a pointer to a user specified class that is used to generate serial
specification.
private gcContainerBase m_userContainer = null;
Indicates if userContainer is used to generate serial or if serial comes from
serialPackage.
Setting based on initialization of pointer to userContainer and
serialPackage.
private boolean m_decodeSerial;
Initialize class instance with provided external name.
void init(String name){ }
Clear value changed and set class to initial conditions with no
serialPackage and no userContainer.
public void reset( ){ }
Set class to initial conditions with no serialPackage and no userContainer.
public void clear( ){ }
Set pointer to userContainer.
public void setUserContainer(gcContainerBase userContainer){ }
Return pointer to serialPackage.
public gcSerialPackage getSerialPackage( ){ }
Set pointer to serialPackage.
public void setSerialPackage(gcSerialPackage serialPackage){ }
Return indicator to use serialPackage or userContainer.
public boolean getDecodeSerial( ){ }
Return pointer to userContainer.
public gcContainerBase getUserContainer( ){ }

TABLE K
gcDataList attributes and methods

Class gcDataList is a convenience class that holds an array of pointers to
gcData classes.
public class gcDataList extends gcListBase
Each pointer to gcData is held within a gcDataEntry with its pointer held
in a dataList.
private ArrayList<gcDataEntry> m_dataList = new
ArrayList<gcDataEntry>( );
Hold an initialized gcDataEntry instance for use to create new instances.
private gcDataEntry m_baseDataEntry;
Hold pointer to class notified upon change to list.
private gcChangeNotifyInterface m_notify;
Hold pointer to map of schema name to corresponding class instance.
private gcSchemaToClassMap m_schemaMap;
Initialize class instance with provided external name.
public gcErrorResult init(String name){ }
Set pointer to change notify class instance.
public void setChangeNotify(gcChangeNotifyInterface changeNotify){ }
Set map used to find class instance from schema name.
public void setSchemaToClassMap(gcSchemaToClassMap
schemaToClassMap){ }
Return map.
public gcSchemaToClassMap getSchemaToClassMap( ){ }
Create gcDataEntry and initialize with gcData pointer. Add gcDataEntry
pointer to list.
public void addData(gcData data){ }
Add gcDataEntry pointer to list.
public void addDataEntry(gcDataEntry dataEntry){ }
Get pointer to gcData from last entry in list.
public gcData getLastData( ){ }
Return list of gcDataEntry pointers.
public ArrayList<gcDataEntry> getList( ){ }
Get next entry in list that is not deleted.
public int getNextEntryId(int id){ }
Get next deleted entry in list.
public int getNextDeletedEntryId(int priorEntryId){ }
Get pointer to gcData from indicated entry.
public gcData getData(int id){ }
Delete indicated entry.
public void deleteEntry(int id){ }
Empty list of all entries.
public void reset( ){ }
Empty list of all entries.
public void clear( ){ }
Place external name into text and call method toXML( ) for every entry in
the list.
public gcErrorResult toXML(StringBuilder xmlBuffer){ }
Place external name into text and call method defaultsToXML( ) for
every entry in the list.
public void defaultsToXML(StringBuilder xmlBuffer){ }

TABLE L
gcConvert methods

Class gcConvert generates serial from gcData and decodes both serial and text into
gcData. Only one instance is used per program.
public class gcConvert
Initialize with a pointer to programBase so that error trace messages can be placed in a
file.
public gcErrorResult init(programBase prgBase){ }
Return an indicator if the last conversion was successful or terminated with an error.
public boolean isError( ){ }
Return error information about the last error encountered.
public gcErrorResult getErrorInfo( ){ }
Set indicator if console user is available to see debug and error messages.
public void setIsConsoleUser(boolean value){ }
Set indicator that extra information messages are desired.
public void setVerbose(boolean verbose){ }
Decode serial into specified gcData class instance using schema map as needed.
public boolean fromSerial(gcData container, gcSerialPackage serialPackage,
gcSchemaToClassMap schemaMap){ }
Decode serial into created gcData instance that corresponds to schema name obtained
from serial using schema map as needed.
public gcData fromSerial(gcSerialPackage serialPackage,
gcSchemaToClassMap schemaMap){ }
Generate serial from indicated gcData pointer. If reportChange is true then encode any
value changed since last serial was generated. Otherwise, encode each value that is not
equal to the default value. Serial is returned in the created gcSerialPackage.
public gcSerialPackage toSerial(gcData container, boolean reportChange){ }
Generate serial from indicated gcData pointer. If reportChange is true then encode any
value changed since last serial was generated. Otherwise, encode each value that is not
equal to the default value. Serial is returned in the indicated gcSerialPackage.
public gcErrorResult toSerial(gcData container, boolean reportChange,
gcSerialPackage toPackage){ }
Decode text into indicated gcData pointer. Create new class instances as needed to hold
array / list entries as they are encountered within text.
public boolean fromXML(gcData container, BufferedReader xmlSource,
gcSchemaToClassMap schemaMap){ }

TABLE M
uiColorSpec that holds RGB specification for color

Line Number:
001 package nelson.eugene.serviceFrame.services.ui;
002 public class uiColorSpec
003 {
004 private int m_r;
005 private int m_g;
006 private int m_b;
007 private int m_a;
008
009
010 public uiColorSpec( )
011 {
012 }
013
014
015 public void initDefault( )
016 {
017 return init(0, 0, 0, 255);
018 }
019
020
021 public void init(int red, int green, int blue, int alpha)
022 {
023 m_r = red;
024 m_g = green;
025 m_b = blue;
026 m_a = alpha;
027 }
028
029
030 public int getRed( )
031{
032 return m_r;
033 }
034
035
036 public int getGreen( )
037 {
038 return m_g;
039 }
040
041
042 public int getBlue( )
043 {
044 return m_b;
045 }
046
047
048 public int getAlpha( )
049 {
050 return m_a;
051 }
052
053
054 public void ensureValid( )
055 {
056 if ((m_r < 0)
057 ∥ (m_r > 255)
058 ∥ (m_g < 0)
059 ∥ (m_g > 255)
060 ∥ (m_b < 0)
061 ∥ (m_b > 255)
062 ∥ (m_a < 0)
063 ∥ (m_a > 255) ) initDefault( );
064 }
065
066
067
068 } //uiColorSpec

TABLE N
uiColorSpec redefined to include metadata

Line Number:
001 //Copyright Eugene Nelson Software 2012 All Rights Reserved
002 //Reproduction or Other Use Only By Permission of Authors
003
004 // uiColorSpec
005
006 package nelson.eugene.serviceFrame.services.ui;
007
008 import nelson.eugene.serviceFrame.gc.*;
009
010
011 public class uiColorSpec extends gcData
012 {
013 private gcIntegerValue m_r;
014 private gcIntegerValue m_g;
015 private gcIntegerValue m_b;
016 private gcIntegerValue m_a;
017
018
019 public uiColorSpec( )
020 {
021 }
022
023
024 public gcErrorResult initDefault( )
025 {
026 return init((uiColorSpec)null);
027 }
028
029
030 public gcErrorResult init(uiColorSpec baseData)
031 {
032 gcErrorResult errorInfo = null;
033 initSchema(“uiColorSpec”, “sfUiColorSpec”);
034
035 m_r = createIntegerValue(“red”, 0, 1);
036 if (m_r == null) return idErr(“uiColorSpec”, 1);
037
038 m_g = createIntegerValue(“green”, 0, 2);
039 if (m_g == null) return idErr(“uiColorSpec”, 2);
040
041 m_b = createIntegerValue(“blue”, 0, 3);
042 if (m_b == null) return idErr(“uiColorSpec”, 3);
043
044 m_a = createIntegerValue(“alpha”, 255, 4);
045 if (m_a == null) return idErr(“uiColorSpec”, 4);
046
047
048 return null;
049 }
050
051 public void init(int red, int green, int blue, int alpha)
052 {
053 m_r.setValue(red);
054 m_g.setValue(green);
055 m_b.setValue(blue);
056 m_a.setValue(alpha);
057 }
058
059
060 public int getRed( )
061 {
062 return m_r.getValue( );
063 }
064
065
066 public int getGreen( )
067 {
068 return m_g.getValue( );
069 }
070
071
072 public int getBlue( )
073 {
074 return m_b.getValue( );
075 }
076
077
078 public int getAlpha( )
079 {
080 return m_a.getValue( );
081 }
082
083
084 public void ensureValid( )
085 {
086 if ((m_r.getValue( ) < 0)
087 ∥ (m_r.getValue( ) > 255)
088 ∥ (m_g.getValue( ) < 0)
089 ∥ (m_g.getValue( ) > 255)
090 ∥ (m_b.getValue( ) < 0)
091 ∥ (m_b.getValue( ) > 255)
092 ∥ (m_a.getValue( ) < 0)
093 ∥ (m_a.getValue( ) > 255) ) reset( );
094 }
095
096
097 public gcData newInstance( )
098 {
099 uiColorSpec newInst = new uiColorSpec( );
100 newInst.init(this);
101 //Ignore duplicate id error as initial creator will report
102 return newInst;
103 }
104
105 } //uiColorSpec

TABLE O
attributes that exist after initialization of uiColorSpec

m_initialized = true;
m_type = 20; value for gcType.DATA
m_name = pointer to “uiColorSpec”; external name that might be
overridden
m_valueChanged = false;
m_notify = null pointer;
m_utf8charset = pointer to Charset for utf8;
m_schemaName = pointer to “sfUiColorSpec”;
m_utf8SchemaName = pointer to byte sequence of
73665569436F6C6F7253706563;
m_lineSeparator = pointer to end of line e.g. CR and LF;
m_valueIds = new ArrayList<Integer>( );
1,
2,
3,
4
m_values = new ArrayList<gcValueBase>( );
pointer to gcIntegerValue of:
m_initialized = true;
m_type = 1; value for gcType.INTEGER
m_name = pointer to “red”;
m_valueChanged = false;
m_notify = null pointer;
m_defaultValue = 0;
m_value = ?; Amount of red from 0 to 255
pointer to gcIntegerValue of:
m_initialized = true;
m_type = 1; value for gcType.INTEGER
m_name = pointer to “green”;
m_valueChanged = false;
m_notify = null pointer;
m_defaultValue = 0;
m_value = ?; Amount of green from 0 to 255
pointer to gcIntegerValue of:
m_initialized = true;
m_type = 1; value for gcType.INTEGER
m_name = pointer to “blue”;
m_valueChanged = false;
m_notify = null pointer;
m_defaultValue = 0;
m_value = ?; Amount of blue from 0 to 255
pointer to gcIntegerValue of:
m_initialized = true;
m_type = 1; value for gcType.INTEGER
m_name = pointer to “alpha”;
m_valueChanged = false;
m_notify = null pointer;
m_defaultValue = 0;

m_value = ?; Transparency from 0 to 255

TABLE P
example data class declaration with embedded metadata

Line Number:
001 // programDefinition
002 package nelson.eugene.serviceFrame.core;
003 import java.util.ArrayList;
004 import nelson.eugene.serviceFrame.gc.*;
005 public class programDefinition extends gcData
006 {
007 //attribute
008 private gcStringValue m_name;
009 private gcEnumValue m_programType;
010 private gcStringValue m_javaClassReference;
011 private gcStringValue m_executableReference;
012 public programDefinition( )
013 {
014 }
015 public gcErrorResult initDefault( )
016 {
017 return init((programDefinition)null);
018 }
019 public gcErrorResult init(programDefinition baseData)
020 {
021 gcErrorResult errorInfo = null;
022 initSchema(“programDefinition”, “sfPrgDef”);
023 m_name = createStringValue(“name”, “”, 1);
024 if (m_name == null) return idErr(“programDefinition”, 1);
025 if (baseData == null)
026 {
027 m_programType = createEnumValue(“programType”, 0, null, 2);
028 if (m_programType == null) return idErr(“programDefinition”, 2);
029 m_programType.addValidName(“UNKNOWN”, 0);
030 m_programType.addValidName(“JAVA”, 1);
031 m_programType.addValidName(“C_SHARP”, 2);
032 m_programType.addValidName(“C_PLUS_PLUS”, 3);
033 }
034 else
035 {
036 m_programType = createEnumValue(“programType”, 0,
037 baseData.m_programType, 2);
038 if (m_programType == null) return idErr(“programDefinition”, 2);
039 }
040 m_javaClassReference = createStringValue(“javaClassReference”, “”, 3);
041 if (m_javaClassReference == null) return idErr(“programDefinition”, 3);
042 m_executableReference = createStringValue(“executableReference”, “”, 4);
043 if (m_executableReference == null) return idErr(“programDefinition”, 4);
044 return null;
045 }
046 public void setName(String name)
047 {
048 m_name.setValue(name);
049 }
050 public void setProgramType(programType value)
051 {
052 m_programType.setValue(value.ordinal( ));
053 }
054 public void setJavaClassReference(String javaClassReference)
055 {
056 m_javaClassReference.setValue(javaClassReference);
057 }
058 public void setExecutableReference(String executableReference)
059 {
060 m_executableReference.setValue(executableReference);
061 }
062 public String getName( )
063 {
064 return m_name.getValue( );
065 }
066 public programType getProgramType( )
067 {
068 programType type = programType.UNKNOWN;
069 switch (m_programType.getValue( ))
070 {
071 case 0 :
072 type = programType.UNKNOWN;
073 break;
074 case 1 :
075 type = programType.JAVA;
076 break;
077 case 2 :
078 type = programType.C_SHARP;
079 break;
080 case 3 :
081 type = programType.C_PLUS_PLUS;
082 break;
083 }
084 return type;
085 }
086 public String getJavaClassReference( )
087 {
088 return m_javaClassReference.getValue( );
089 }
090 public String getExecutableReference( )
091 {
092 return m_executableReference.getValue( );
093 }
094 public gcData newInstance( )
095 {
096 programDefinition newInst = new programDefinition( );
097 newInst.init(this);
098 //Ignore duplicate id error as initial creator will report
099 return newInst;
100 }
101 } //programDefinition

TABLE Q
programDefinition text format with defaults

Line Number:
001 <programDefinition>
002 <dataSchemaName>sfPrgDef</dataSchemaName>
003 <name></name>
004 <programType>UNKNOWN</programType>
005 <javaClassReference></javaClassReference>
006 <executableReference></executableReference>
007 </programDefinition>

TABLE R
programDefinition configuration text format

Line Number:
001 <programDefinition>
002 <dataSchemaName>sfPrgDef</dataSchemaName>
003 <name>hub</name>
004 <programType>JAVA</programType>
005
<javaClassReference>nelson.eugene.serviceFrame.fred.hub.sfHub</javaClassReferen
ce>
006 </programDefinition>

TABLE S
serial shown in hexadecimal

Filename = C:\ServiceFrame\versions\0001\config\systemConfig,
contents =
001 a0 00 02 00 00 0e 73 66 53 79 73 74 65 6d 43 6f
002 6e 66 69 67 9a 00 00 00 00 09 00 01 10 74 65 73
003 74 53 65 72 76 69 63 65 46 72 61 6d 65 38 02 02
004 aa 04 00 00 00 02 9a 00 00 00 00 02 38 01 01 a0
005 02 02 00 00 07 73 66 4c 68 44 65 66 9a 00 00 00
006 00 03 00 01 09 6c 6f 63 61 6c 48 75 62 31 48 02
007 01 00 00 07 31 2e 34 2e 31 2e 31 09 03 25 e4 9a
008 00 00 00 00 02 38 01 01 a0 02 02 00 00 07 73 66
009 4c 68 44 65 66 9a 00 00 00 00 03 00 01 09 6c 6f
010 63 61 6c 48 75 62 32 48 02 01 00 00 07 31 2e 34
011 2e 31 2e 32 09 03 25 e4 aa 05 00 00 00 02 9a 00
012 00 00 00 02 38 01 01 a0 02 02 00 00 07 73 66 4d
013 68 44 65 66 9a 00 00 00 00 05 00 01 09 6d 61 69
014 6e 48 75 62 41 31 00 02 0d 31 39 32 2e 31 36 38
015 2e 30 2e 31 30 30 00 03 00 09 04 26 48 09 05 26
016 49 9a 00 00 00 00 02 38 01 01 a0 02 02 00 00 07
017 73 66 4d 68 44 65 66 9a 00 00 00 00 05 00 01 09
018 6d 61 69 6e 48 75 62 41 32 00 02 0d 31 39 32 2e
019 31 36 38 2e 30 2e 31 30 31 00 03 00 09 04 26 48
020 09 05 26 49 aa 06 00 00 00 00 00 07 29 43 3a 5c
021 65 65 6e 5c 53 65 72 76 69 63 65 46 72 61 6d 65
022 5c 72 65 6c 65 61 73 65 30 2e 31 5c 73 6f 75 72
023 63 65 5c 73 72 63 aa 08 00 00 00 0a 9a 00 00 00
024 00 02 38 01 01 a0 02 02 00 00 08 73 66 50 72 67
025 44 65 66 9a 00 00 00 00 03 00 01 07 6d 61 69 6e
026 48 75 62 38 02 01 00 03 2e 6e 65 6c 73 6f 6e 2e
027 65 75 67 65 6e 65 2e 73 65 72 76 69 63 65 46 72
028 61 6d 65 2e 66 72 65 64 2e 6d 61 69 6e 2e 73 66
029 4d 61 69 6e 48 75 62 9a 00 00 00 00 02 38 01 01
030 a0 02 02 00 00 08 73 66 50 72 67 44 65 66 9a 00
031 00 00 00 03 00 01 08 6c 6f 63 61 6c 48 75 62 38
032 02 01 00 03 30 6e 65 6c 73 6f 6e 2e 65 75 67 65
033 6e 65 2e 73 65 72 76 69 63 65 46 72 61 6d 65 2e
034 66 72 65 64 2e 6c 6f 63 61 6c 2e 73 66 4c 6f 63
035 61 6c 48 75 62 9a 00 00 00 00 02 38 01 01 a0 02
036 02 00 00 08 73 66 50 72 67 44 65 66 9a 00 00 00
037 00 03 00 01 03 68 75 62 38 02 01 00 03 29 6e 65
038 6c 73 6f 6e 2e 65 75 67 65 6e 65 2e 73 65 72 76
039 69 63 65 46 72 61 6d 65 2e 66 72 65 64 2e 68 75
040 62 2e 73 66 48 75 62 9a 00 00 00 00 02 38 01 01
041 a0 02 02 00 00 08 73 66 50 72 67 44 65 66 9a 00
042 00 00 00 03 00 01 0a 73 66 41 73 73 69 67 6e 65
043 72 38 02 01 00 03 31 6e 65 6c 73 6f 6e 2e 65 75
044 67 65 6e 65 2e 73 65 72 76 69 63 65 46 72 61 6d
045 65 2e 66 72 65 64 2e 61 73 73 69 67 6e 2e 73 66
046 41 73 73 69 67 6e 65 72 9a 00 00 00 00 02 38 01
047 01 a0 02 02 00 00 08 73 66 50 72 67 44 65 66 9a
048 00 00 00 00 03 00 01 0a 73 66 52 65 63 6f 72 64
049 65 72 38 02 01 00 03 31 6e 65 6c 73 6f 6e 2e 65
050 75 67 65 6e 65 2e 73 65 72 76 69 63 65 46 72 61
051 6d 65 2e 66 72 65 64 2e 72 65 63 6f 72 64 2e 73
052 66 52 65 63 6f 72 64 65 72 9a 00 00 00 00 02 38
053 01 01 a0 02 02 00 00 08 73 66 50 72 67 44 65 66
054 9a 00 00 00 00 03 00 01 0b 73 66 45 76 65 6e 74
055 54 65 73 74 38 02 01 00 03 33 6e 65 6c 73 6f 6e
056 2e 65 75 67 65 6e 65 2e 73 65 72 76 69 63 65 46
057 72 61 6d 65 2e 66 72 65 64 2e 73 61 6d 70 6c 65
058 73 2e 73 66 45 76 65 6e 74 54 65 73 74 9a 00 00
059 00 00 02 38 01 01 a0 02 02 00 00 08 73 66 50 72
060 67 44 65 66 9a 00 00 00 00 03 00 01 08 73 66 43
061 6c 69 65 6e 74 38 02 01 00 03 30 6e 65 6c 73 6f
062 6e 2e 65 75 67 65 6e 65 2e 73 65 72 76 69 63 65
063 46 72 61 6d 65 2e 66 72 65 64 2e 73 61 6d 70 6c
064 65 73 2e 73 66 43 6c 69 65 6e 74 9a 00 00 00 00
065 02 38 01 01 a0 02 02 00 00 08 73 66 50 72 67 44
066 65 66 9a 00 00 00 00 03 00 01 08 73 66 53 65 72
067 76 65 72 38 02 01 00 03 30 6e 65 6c 73 6f 6e 2e
068 65 75 67 65 6e 65 2e 73 65 72 76 69 63 65 46 72
069 61 6d 65 2e 66 72 65 64 2e 73 61 6d 70 6c 65 73
070 2e 73 66 53 65 72 76 65 72 9a 00 00 00 00 02 38
071 01 01 a0 02 02 00 00 08 73 66 50 72 67 44 65 66
072 9a 00 00 00 00 03 00 01 0d 73 66 53 65 72 76 69
073 63 65 45 78 65 63 38 02 01 00 03 2d 6e 65 6c 73
074 6f 6e 2e 65 75 67 65 6e 65 2e 73 65 72 76 69 63
075 65 46 72 61 6d 65 2e 65 78 65 63 2e 73 66 53 65
076 72 76 69 63 65 45 78 65 63 9a 00 00 00 00 02 38
077 01 01 a0 02 02 00 00 08 73 66 50 72 67 44 65 66
078 9a 00 00 00 00 03 00 01 10 73 66 53 65 72 76 69
079 63 65 4d 61 6e 61 67 65 72 38 02 01 00 03 38 6e
080 65 6c 73 6f 6e 2e 65 75 67 65 6e 65 2e 73 65 72
081 76 69 63 65 46 72 61 6d 65 2e 65 78 65 63 2e 6d
082 61 6e 61 67 65 72 2e 73 66 53 65 72 76 69 63 65
083 4d 61 6e 61 67 65 72 aa 09 00 00 00 0d 9a 00 00
084 00 00 02 38 01 01 a0 02 02 00 00 0b 73 66 50 72
085 67 43 70 79 44 65 66 9a 00 00 00 00 04 00 01 0a
086 73 66 41 73 73 69 67 6e 65 72 00 02 00 48 03 02
087 00 00 09 6c 6f 63 61 6c 48 75 62 31 00 01 09 6c
088 6f 63 61 6c 48 75 62 32 30 04 01 9a 00 00 00 00
089 02 38 01 01 a0 02 02 00 00 0b 73 66 50 72 67 43
090 70 79 44 65 66 9a 00 00 00 00 04 00 01 0a 73 66
091 52 65 63 6f 72 64 65 72 00 02 00 48 03 02 00 00
092 09 6c 6f 63 61 6c 48 75 62 31 00 01 09 6c 6f 63
093 61 6c 48 75 62 32 30 05 01 9a 00 00 00 00 02 38
094 01 01 a0 02 02 00 00 0b 73 66 50 72 67 43 70 79
095 44 65 66 9a 00 00 00 00 03 00 01 0b 73 66 45 76
096 65 6e 74 54 65 73 74 00 02 01 41 48 03 01 00 00
097 09 6c 6f 63 61 6c 48 75 62 31 9a 00 00 00 00 02
098 38 01 01 a0 02 02 00 00 0b 73 66 50 72 67 43 70
099 79 44 65 66 9a 00 00 00 00 03 00 01 0b 73 66 45
100 76 65 6e 74 54 65 73 74 00 02 01 42 48 03 01 00
101 00 09 6c 6f 63 61 6c 48 75 62 32 9a 00 00 00 00
102 02 38 01 01 a0 02 02 00 00 0b 73 66 50 72 67 43
103 70 79 44 65 66 9a 00 00 00 00 03 00 01 08 73 66
104 53 65 72 76 65 72 00 02 00 48 03 02 00 00 09 6c
105 6f 63 61 6c 48 75 62 31 00 01 09 6c 6f 63 61 6c
106 00 00 0b 73 66 50 72 67 43 70 79 44 65 66 9a 00
107 00 00 00 04 00 01 08 73 66 43 6c 69 65 6e 74 00
108 02 00 48 03 02 00 00 09 6c 6f 63 61 6c 48 75 62
109 31 00 01 09 6c 6f 63 61 6c 48 75 62 32 00 06 08
110 73 66 53 65 72 76 65 72 9a 00 00 00 00 02 38 01
111 01 a0 02 02 00 00 0b 73 66 50 72 67 43 70 79 44
112 65 66 9a 00 00 00 00 03 00 01 10 73 66 53 65 72
113 76 69 63 65 4d 61 6e 61 67 65 72 00 02 00 48 03
114 02 00 00 09 6c 6f 63 61 6c 48 75 62 31 00 01 09
115 6c 6f 63 61 6c 48 75 62 32 9a 00 00 00 00 02 38
116 01 01 a0 02 02 00 00 0b 73 66 50 72 67 43 70 79
117 44 65 66 9a 00 00 00 00 04 00 01 0d 73 66 53 65
118 72 76 69 63 65 45 78 65 63 00 02 09 66 69 6c 65
119 31 54 65 73 74 48 03 01 00 00 09 6c 6f 63 61 6c
120 48 75 62 31 00 06 10 73 66 53 65 72 76 69 63 65
121 4d 61 6e 61 67 65 72 9a 00 00 00 00 02 38 01 01
122 a0 02 02 00 00 0b 73 66 50 72 67 43 70 79 44 65
123 66 9a 00 00 00 00 04 00 01 0d 73 66 53 65 72 76
124 69 63 65 45 78 65 63 00 02 06 73 46 69 6c 65 31
125 48 03 02 00 00 09 6c 6f 63 61 6c 48 75 62 31 00
126 01 09 6c 6f 63 61 6c 48 75 62 32 00 06 10 73 66
127 53 65 72 76 69 63 65 4d 61 6e 61 67 65 72 9a 00
128 00 00 00 02 38 01 01 a0 02 02 00 00 0b 73 66 50
129 72 67 43 70 79 44 65 66 9a 00 00 00 00 04 00 01
130 0d 73 66 53 65 72 76 69 63 65 45 78 65 63 00 02
131 07 75 69 4c 6f 63 61 6c 48 03 01 00 00 09 6c 6f
132 63 61 6c 48 75 62 32 00 06 10 73 66 53 65 72 76
133 69 63 65 4d 61 6e 61 67 65 72 9a 00 00 00 00 02
134 38 01 01 a0 02 02 00 00 0b 73 66 50 72 67 43 70
135 79 44 65 66 9a 00 00 00 00 04 00 01 0d 73 66 53
136 65 72 76 69 63 65 45 78 65 63 00 02 07 75 69 54
137 65 73 74 31 48 03 01 00 00 09 6c 6f 63 61 6c 48
138 75 62 31 00 06 10 73 66 53 65 72 76 69 63 65 4d
139 61 6e 61 67 65 72 9a 00 00 00 00 02 38 01 01 a0
140 02 02 00 00 0b 73 66 50 72 67 43 70 79 44 65 66
141 9a 00 00 00 00 04 00 01 0d 73 66 53 65 72 76 69
142 63 65 45 78 65 63 00 02 0c 72 65 63 6f 76 65 72
143 79 44 65 6d 6f 48 03 01 00 00 09 6c 6f 63 61 6c
144 48 75 62 31 00 06 10 73 66 53 65 72 76 69 63 65
145 4d 61 6e 61 67 65 72 9a 00 00 00 00 02 38 01 01
146 a0 02 02 00 00 0b 73 66 50 72 67 43 70 79 44 65
147 66 9a 00 00 00 00 04 00 01 0d 73 66 53 65 72 76
148 69 63 65 45 78 65 63 00 02 0b 75 73 65 72 4d 61
149 6e 61 67 65 72 48 03 01 00 00 09 6c 6f 63 61 6c
150 48 75 62 32 00 06 10 73 66 53 65 72 76 69 63 65
151 4d 61 6e 61 67 65 72 30 0f 01

What is claimed is:

1. A computerized method for transforming real-data in RAM of a computer into other formats comprising:
a) using a computer processor to update in the RAM the real-data associated with a first and second data structure according to programming instructions operating on the computer processor, the first and second data structures each having a plurality of attributes of a plurality of attribute types;
b) using the computer processor to maintain in the RAM attribute-list metadata that defines a first list of all the attributes in the first data structure and a second list of all the attributes in the second data structure;
c) using the computer processor to maintain in the RAM attribute-type metadata that associates each attribute in the first and second data structures with a specific attribute type;
d) receiving, at the computer processor, a request to transform real-data in RAM into a first output type;
e) using the computer processor to transform the real-data associated with the first data structure by separately selecting and processing attributes in the first list of attributes and to transform the real-data associated with the second data structure by separately selecting and processing attributes in the second list of attributes, wherein each selected attribute is processed by:
i) identifying the specific attribute type for the selected attribute by examining the attribute-type metadata maintained in RAM,
ii) identifying a first-output-type transform algorithm for the specific attribute type, and
iii) applying the identified first-output-type transform algorithm on the real-data associated with the selected attribute to generate a transformed real-data value for the selected attribute of the first output type;
wherein attributes of the first data structure having the same attribute type as attributes of the second data structure are transformed using the same transform algorithm.

2. The computerized method of claim 1, wherein the step of using the computer processor to transform the real-data further comprises including with the transformed real-data values a schema name associated with at least one of the first and second data structures.

3. The computerized method of claim 1, wherein all attributes in the attribute-list metadata for the first and second data structures are selected and processed.

4. The method of claim 1, wherein the first output type transform algorithm transforms real-data in RAM into human readable text, wherein the method further comprises:
f) embedding each transformed real-data value within XML tags.

5. The method of claim 1, wherein the first output type transform algorithm transforms real-data in RAM into serial data, wherein the method further comprises:
f) using the computer processor to transmit each transformed real-data value within a serial data stream, wherein each transformed real-data value is preceded with a header that identifies the selected attribute and the size of the transformed real-data value.

6. The computerized method of claim 1, further comprising:
f) receiving, at the computer processor, a second request to transform real-data in RAM into a second output type;
g) using the computer processor to transform the real-data associated with the first data structure by separately selecting and processing attributes in the first list of attributes and to transform the real-data associated with the second data structure by separately selecting and processing attributes in the second list of attributes, wherein the selected attributes are processed by:
i) identifying the specific attribute type for the selected attribute by examining the attribute-type metadata maintained in RAM,
ii) identifying a second-output-type transform algorithm for the specific attribute type, and
iii) applying the identified second-output-type transform algorithm on the real-data associated with the selected attribute to generate a transformed real-data value for the selected attribute of the second output type.

7. The computerized method of claim 1, further comprising maintaining default-value metadata that associates at least one attribute in the first data structure with a default value, wherein the identified first-output-type transform algorithm is applied only to attributes having real-data that differs from the associated default value in the default-value metadata.

8. The method of claim 7, further comprising maintaining identifier metadata that associates each attribute in the first data structure with an identifier unique to the first data structure, and wherein the step of applying the identified first-output-type transform algorithm further comprises associating each transformed real-data value with the associated identifier for that attribute.

9. The method of claim 8, further comprising:
f) transmitting each transformed real-data value within a serial data stream, wherein each transformed real-data value is preceded with a header that includes the associated identifier for the selected attribute and the size of the transformed real-data value.

10. The method of claim 1, further comprising:
f) programming program instructions defining the first data structure in a compiled language, wherein the program instructions do not identify techniques for storing the attribute-list metadata and attribute-type metadata in RAM;
g) compiling the program instructions with a compiler, wherein the compiling automatically generates machine language instructions to maintain the attribute-list metadata and the attribute-type metadata in RAM.

11. The method of claim 1, further comprising:
f) programming program instructions defining the first data structure in an object oriented language, wherein the program instructions define the first data structure as a user class, wherein the user class incorporates a values convenience class that maintains the attribute-list metadata and the attribute-type metadata for the user class.

12. The method of claim 1, further comprising:
f) programming program instructions defining the data structures in an object oriented language, wherein the program instructions define the data structures as user-defined classes, wherein the user-defined classes are further defined by a plurality of convenience classes, wherein the convenience classes comprise a values-level convenience class that maintains the attribute-list metadata, further wherein each attribute in the data structures is defined using a separate convenience class, wherein each convenience class has its own attribute type.

13. The method of claim 12, wherein the values-level convenience class contains transform algorithms for primitive classes.

14. The method of claim 12, wherein each convenience class contains a transform algorithm for the attribute type of that convenience class.

15. The method of claim 14, wherein each convenience class contains the real-data value for the attribute defined using that convenience class.

16. A method for processing data comprising:
a) using a computer processor to access a collection of data comprising a data structure, the data structure having a plurality of attributes having a plurality of attribute types;
b) using the computer processor to identify within the collection of data a schema name associated with the data structure;
c) using the computer processor to identify schema metadata based on the schema name, wherein the schema metadata is accessed by the computer processor from outside the collection of data; and
d) using the computer processor to separately process attributes in the collection of data, wherein the selected attributes are processed by:
i) identifying a real-data value for the selected attribute in the collection of data;
ii) using the schema metadata to identify an attribute type for the selected attribute,
iii) using the attribute type to identify a transform algorithm for the selected attribute,
iv) applying the transform algorithm on the real-data value to generate a transformed real-data value for the selected attribute, and
v) placing the transformed real-data value in RAM according to the schema metadata.

17. The method of claim 16, further comprising:
e) identifying, using the schema metadata, missing attributes that were not included within the collection of data;
f) using the computer processor to process each missing attribute by:
i) identifying in the schema metadata a default value for the missing attribute;
ii) placing the default value for the missing attribute in RAM according to the schema metadata.

18. The method of claim 16, wherein the collection of data is human-readable text.

19. The method of claim 18, wherein the human-readable text is XML.

20. The method of claim 16, wherein the collection of data is received from a remote computer via a serial data stream, and further wherein the schema metadata is stored locally with respect to the computer processor and is not received from the remote computer.

21. A computerized method for transmitting data from a transmitting computer to a receiving computer over a serial data stream comprising:
a) at the transmitting computer, maintaining in transmitting-computer RAM:
i) real-data associated with a data structure that has a plurality of attributes of a plurality of attribute types,
ii) attribute-list metadata that defines a list of all the attributes in the data structure,
iii) attribute-type metadata that associates each attribute in the data structure with a specific attribute type;
b) at the transmitting computer, separately selecting and processing attributes in the attribute-list metadata, wherein the selected attributes are processed by:
i) identifying a specific attribute type for the selected attribute by examining the attribute-type metadata,
ii) identifying a serial encode algorithm for the specific attribute type, and
iii) applying the identified serial encode algorithm on the real-data associated with the selected attribute to generate a serial real-data value for the selected attribute;
c) at the transmitting computer, transmitting each serial real-data value within the serial data stream that contains a schema name for the data structure, wherein each serial real-data value in the serial data stream is preceded with a header that indicates a size of the serial real-data value;
d) at the receiving computer, receiving the serial data stream and retrieving the schema name from the serial data stream;
e) at the receiving computer, identifying and accessing schema metadata based on the schema name, wherein the schema metadata was not transmitted in the serial data stream;
f) at the receiving computer, separately processing attributes in the serial data stream, wherein the attributes are processed by
i) selecting a particular serial real-data value,
ii) using the schema metadata to identify the attribute type for the particular serial real-data value,
iii) using the attribute type to identify a serial decode algorithm for the particular serial real-data value,
iv) applying the serial decode algorithm to the particular serial real-data value to generate a transformed real-data value, and
v) placing the transformed real-data value in receiving-computer RAM according to the schema metadata.

22. The method of claim 21, wherein the transmitting computer further maintains attribute identifier metadata that assigns a unique identifier for each attribute in the data structure, and further wherein the header that precedes each serial real-data value in the serial data stream includes the unique identifier for that serial real-data value.

23. The method of claim 22, wherein the transmitting computer further maintains default-value metadata that assigns a default value for at least one attribute in the data structure, wherein the transmitting computer includes only non-default real-data values in the serial data stream, wherein the schema metadata further indicates the default value for the at least one attribute, and further wherein the receiving computer identifies missing values in the serial data stream and places the default value for missing data into the receiving-computer RAM.
